(19) United States
(12) Patent Application Publication
(10) Pub. No.: US 2020/0305455 A1
(43) Pub. Date: Oct. 1, 2020

(54) Amylose-Lipid Complexes

(71) Applicants: Council of Scientific Industrial Research, Lynnwood, Pretoria (ZA); University of Pretoria, Hatfield, Pretoria (ZA)

(72) Inventors: Ray Sinha Suprakas, Pretoria (ZA); Mohammad Naushad Emmabux, Pretoria (ZA); Obiro Wokadala, Mutond (UG)

(21) Appl. No.: 15/779,900

(22) PCT Filed: Nov. 30, 2015
(86) PCT No.: PCT/ZA2015/050029

§ 371 Date: May 30, 2018

(51) Int. Cl. A23D 7/005; A23D 7/04; A23D 7/015

(52) U.S. Cl. CPC A23D 7/0056; A23D 7/015; A23D 7/04

(57) ABSTRACT

The invention provides a method for the manufacture of amylose-lipid complexes The method includes the steps of pasting a mixture of starch and a fatty acid until after the second biphasic peak viscosity is reached, hydrolysing the starch with a hydrolysing enzyme, and dispersing the hydrolysed starch and working up of the residue. The amylose-lipid complexes has nano-structure dimensions and can be used a fat replacer in foodstuffs.

### TECHNICAL FIELD OF THE INVENTION

This invention relates to a method for synthesising amylose-lipid complexes.

### BACKGROUND TO THE INVENTION

The production of composite starch nanoparticles is described in WO 2011/004944. Dissolved starch is combined with various functional components. The components can be any substance capable of forming a complex with the starch chain, and ethanol, propanol, butanol, pentanol, hexanol, heptanol, octanol, nonanol, decanol and the respective alcohols and the isomeric, beta-carotene, retinol, such as carotenoid-based material, vitamin A, vitamin E, CoQ10, such as fat-soluble vitamins, resichin, DHA, fatty acids such as EPA, menthone, linalool, graniol, decanal, 1-paphtol, flavour ingredients and a hydrophobic drug, such as capsaicin. The typically hydrophobic non water soluble functional components are water soluble in the combined or nanoparticle form. The nanoparticles increase the stability and in-vivo absorption of the functional components. The method described includes the steps of: a) dissolving in an aqueous solvent, a straight-chain starch or dextrin; b) the step of dissolving a functional material in a hydrophobic solvent; c) mixing the hydrophobic solution and the starch or the cyclodextrin aqueous solution; and d) changing the structure of the product with enzymatic or acid treatment to a V-amylose on a nano scale. The hydrophobic solvent includes hexane, cyclohexane, ISO-propyl ether, decalin, methyl tert-butyl ether and ethyl ether.

The manufacture of starch only nanoparticles are described in Korean patent KR 100873015 and the Elsevier publication of “Starch nanoparticle formation via reactive extrusion and related mechanism study” by Song et al Volume 85 Issue 1, 22 April 2011, Pages 208 to 214.

The potential applications of starch nanostructures include; encapsulation and delivery of bioactive or sensitive food ingredients; preparation of bio-composites for improved material properties and biodegradability in food packaging; and food fat replacement due to mimicking of fat micelles; nano-sized starch structures may also exhibit novel functional and physical properties relative to their parent material due to a larger surface area to mass ratio. However, in order to facilitate application of nanomaterials in food systems; economically viable yields, preparation times and use of food compatible solvents are required during the preparation of nanomaterials.

It is an object of the invention to provide a new method for the manufacture of nanoparticles of amylose-lipid complexes with a high yield and without the use of any solvents unfit for human consumption.

The inventors are aware that there has been increased market demand for low fat foods due to increased awareness of the fact that high fat intake is correlated with the occurrence of lifestyle diseases such as coronary heart disease, obesity and diabetes (Jonnalagadda and Jones, 2005; Lim, Inglett and Lee, 2010; Sandrou and Arvanitoyannis, 2000). Various food innovations have been developed to enable consumers reduce total fat intake, for example, carbohydrate based fat replacers (Lim et al., 2010; Lucca and Tepper, 1994; Warshaw, Franz, Powers and Wheeler, 1996).

Starch based fat replacers are recommended based on the fact that carbohydrates such as starch supply a maximum four calories per gram while fat gives nine calories per gram (Lucca and Tepper, 1994; Yackel and Cox, 1992). Fat, however, plays an important role in the sensory acceptability of foods because it influences the viscosity of the food and the release or perception of food flavours (Lucca and Tepper, 1994). It is, therefore, necessary to ensure that fat-replaced foods have a rheological or textural character similar to that of the corresponding full fat foods (Lim et al., 2010; Lucca and Tepper, 1994).

The mimicking of the fat mouth feel by starch particles was suggested to result from a complex interaction between perception of viscosity and flow-ability of a food product (Ma, Cai, Wang and Sun, 2006). Submicron and micron structured starch particles are suggested to mimic fats through forming weak aggregates in continuous aqueous phases that give a smooth, creamy, fat-like mouth-feel and texture (Harris and Day, 1993; Jane, 1992). Some studies have demonstrated that micron or submicron structured starches have the capacity to function as fat replacers in plain set yoghurt (Singh and Byars, 2009), soft-serve ice cream (Byars, 2002), cake icing (Singh and Byars, 2011), low-fat beef patties (Garzoan, Mckeith, Gooding, Felker, Palmquist and Brewer, 2003), frozen desert (Malinski et al., 2003), and mayonnaise (Ma et al., 2006).

High-amylose corn starch (approximately 70% w/w amylose) modified with palmitic or oleic acid through steam jet cooking was demonstrated to contain submicron-micron scale structured amylose-lipid complexes whose aqueous dispersions at a high concentration (16% w/w) were spreadable and had flow properties similar to those of a commercial shortening (Byars et al., 2009). The aqueous dispersions of the submicron-micron structured high-amylose corn starch did not form gels (Byars et al., 2009). A non-gelling paste is also formed by normal maize and tef starch that is wet-heat processed for a prolonged time in a rapid visco-analyser (RVA) (D'silva et al., 2011).

A further objective of the invention is to provide a fat replacer for low calorie foodstuffs.

### GENERAL DESCRIPTION OF THE INVENTION

According to the invention there is provided a method for the manufacture of amylose-lipid complexes, which method includes the steps of:

pasting a mixture of starch and a fatty acid until after the second biphasic peak viscosity is reached;

hydrolysing the starch with a hydrolysing enzyme; and

dispersing the hydrolysed starch and working up of the residue.

The starch can be selected from maize, tef, wheat, millet, sorghum) the like starch.

The fatty acids can be selected from saturated fatty acids such as stearic acid (octadecanoic acid) and palmitic acid (hexadecanoic acid).

The pasting step also known as wet heat processing can be executed in a RVA or starch pasting rheometer may last for 130 minutes or more.

The hydrolysing step may be thermo-stable alpha-amylase hydrolysis.

The hydrolysing step may be followed by a buffer treatment such as acetate buffer treatment to inactive the enzymes. The buffer may typically have a concentration of 0.05 M with a pH of 3.5 and the treatment may be at 95° C. for 20 min.

The tef and maize nanomaterial isolated before acetate buffer treatment had distinct particles of about 3-10 nm and 2.4-6.7 nm, respectively. The nanomaterial isolated after acetate buffer treatment had a size of about 6.1-94 nm and 6.2-64.7 nm for tef and maize respectively.

The isolated residues consisted of V6I and V6II-amylose-lipid complexes for the residues isolated before and after acetate buffer treatment, respectively or Type II V-amylose-lipid complexes. Before hydrolysis the residue consists of non-distinct particles, which become distinct with hydrolysis.

The invention also extends to the use of amylose-lipid complexes manufactured according to a method described above in food stuffs as a fat replacer.

The use of amylose-lipid complexes wherein between 25% and 50% w/w of a low calorie spread is replaced with amylose-lipid complexes.

A low calorie spread which includes a spread and between 25% and 50% w/w amylose-lipid complexes.

A low calorie spread wherein the spread is selected from margarine.

### DETAILED DESCRIPTION OF THE INVENTION

The invention is now described by way of example.

In the drawings:

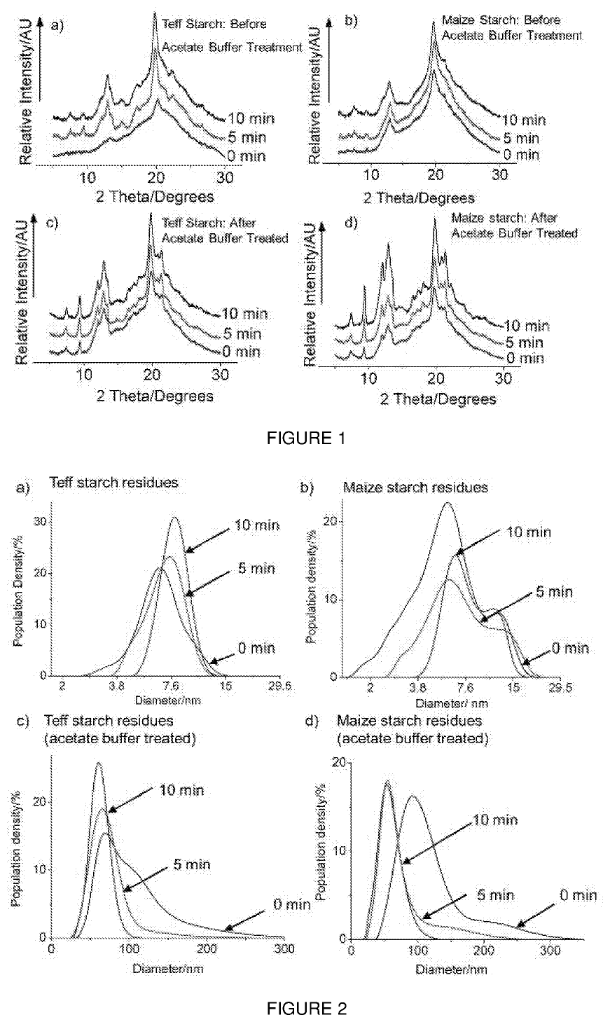

FIG. 1 shows X-ray diffractograms of isolated tef and maize starch residues after hydrolysis with thermostable alpha-amylase hydrolysis at 75° C. for 0, 5 and 10 minutes;

FIG. 2 shows particle size distribution of tef and maize starch residues isolated before or after acetate buffer treatment following thermostable alpha-amylase hydrolysis at 75° C. for 0, 5, and 10 minutes;

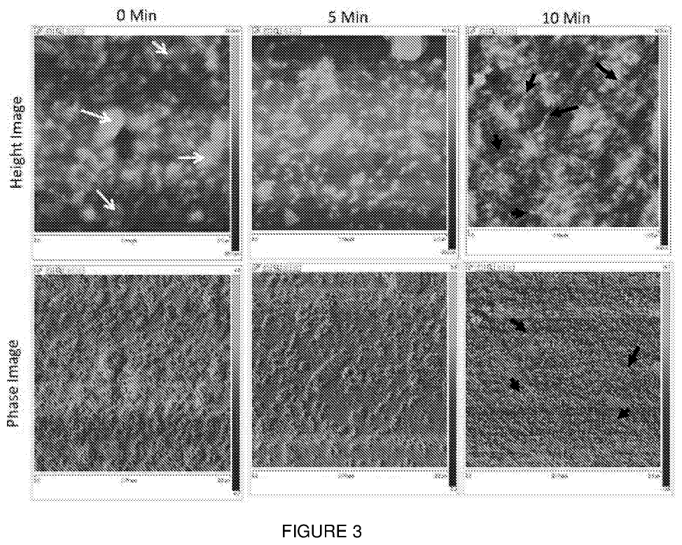

FIG. 3 shows Atomic force microscopy (AFM) 2-dimension height and phase images tef starch residues isolated before acetate buffer treatment after thermostable alpha-amylase hydrolysis at 75° C. for 0, 5, and 10 minutes;

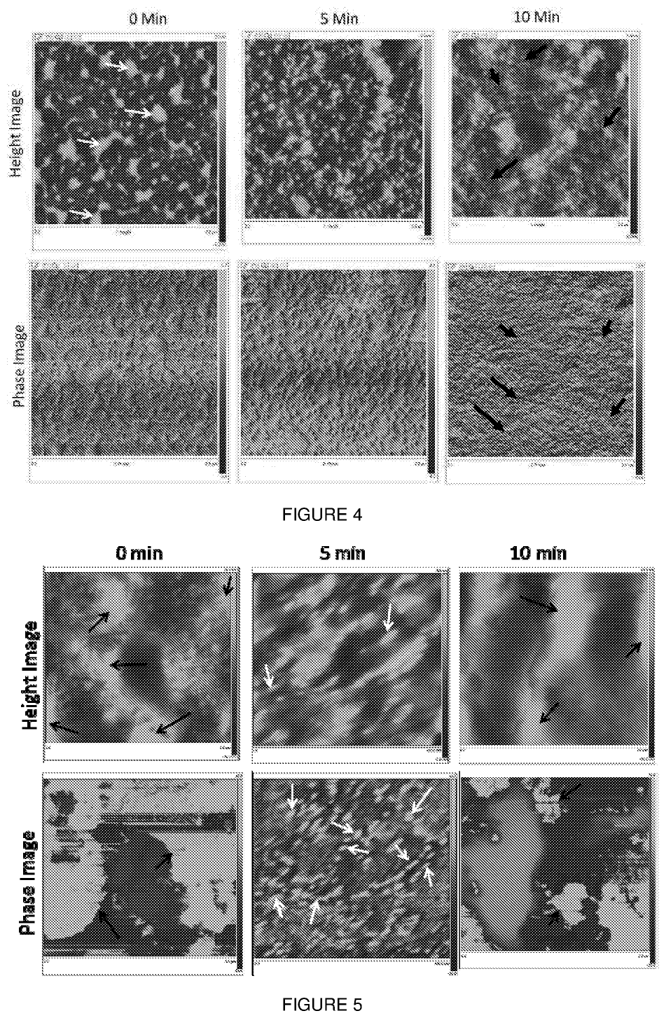

FIG. 4 shows AFM 2-dimension height and phase images maize starch residues isolated before acetate buffer treatment after thermostable alpha-amylase hydrolysis at 75° C. for 0, 5, and 10 minutes;

FIG. 5 shows AFM 2-dimension height and phase images tef starch residues isolated after acetate buffer treatment after thermostable alpha-amylase hydrolysis at 75° C. for 0, 5, and 10 minutes;

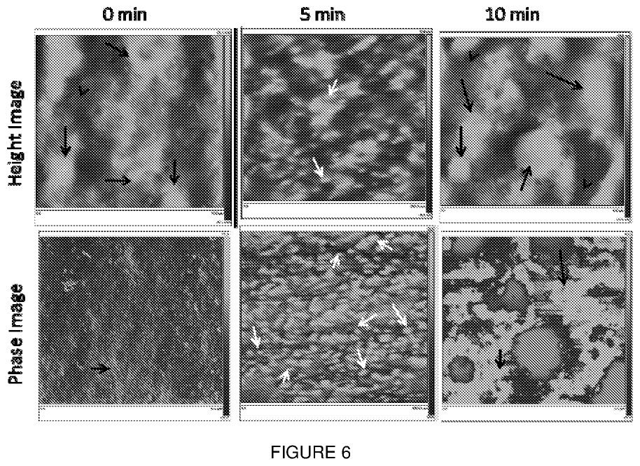

FIG. 6 shows AFM 2-dimension height and phase images maize starch residues isolated after acetate buffer treatment after thermostable alpha-amylase hydrolysis at 75° C. for 0, 5, and 10 minutes;

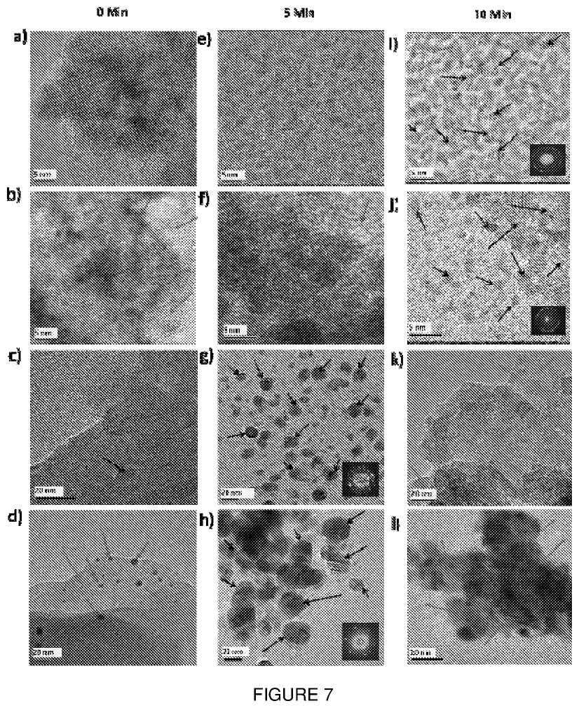

FIG. 7 shows high resolution transmission electron microscopy (HRTEM) images of tef and maize starch paste residues isolated before (a,b,d,e,h,i) and after (c,d,f,g,j,k) acetate buffer treatment that followed hydrolysis of second biphasic pastes with thermostable alpha-amylase at 75° C. for 0, 5, and 10 minutes;

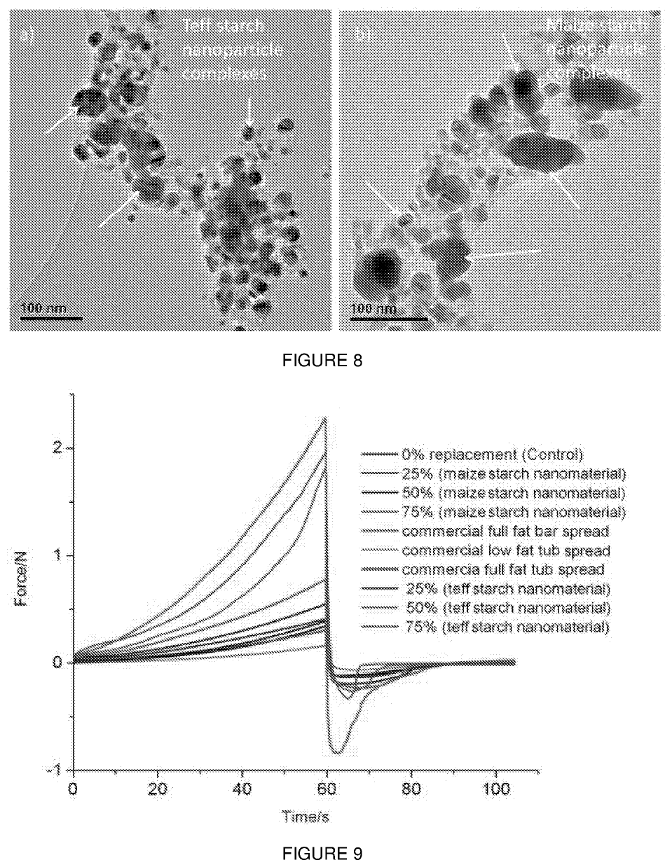

FIG. 8 shows HRTEM images of isolated tef (a) and maize (b) nanomaterial. The bold white arrows indicate individual nanoparticles;

FIG. 9 shows textural profiles of spreads fat-replaced with aqueous dispersions of tef and maize starch nanomaterial compared to reference commercial full fat and low spreads;

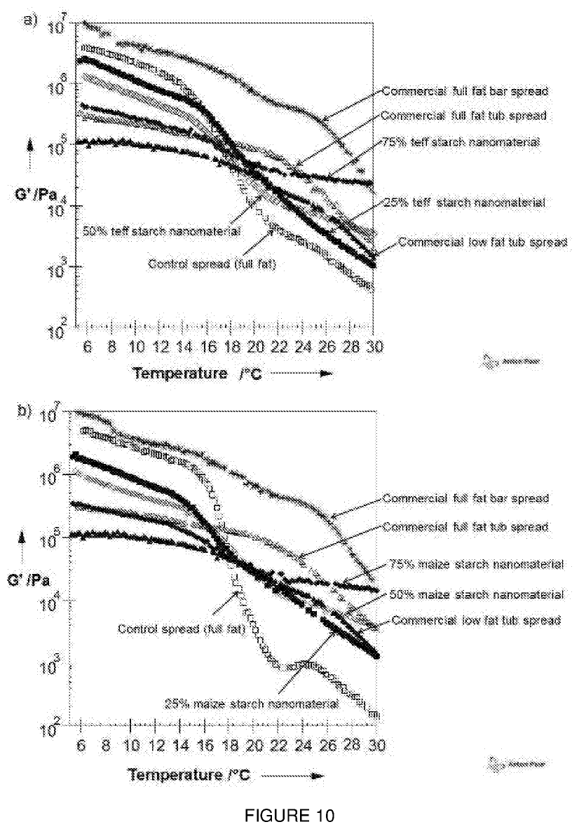

FIG. 10 shows the effect of temperature on G′ of low-calorie spreads fat-replaced with tef (a) and maize (b) starch nanomaterial aqueous dispersions and commercial (low and full fat) reference spreads;

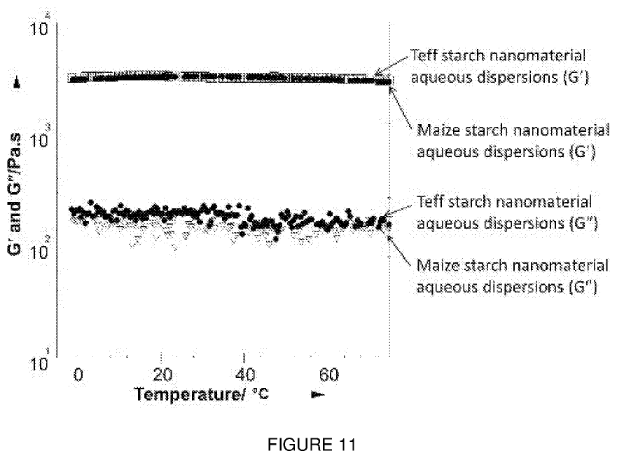

FIG. 11 shows the effect of temperature on storage and loss modulus of aqueous dispersions of tef and maize starch nanomaterial;

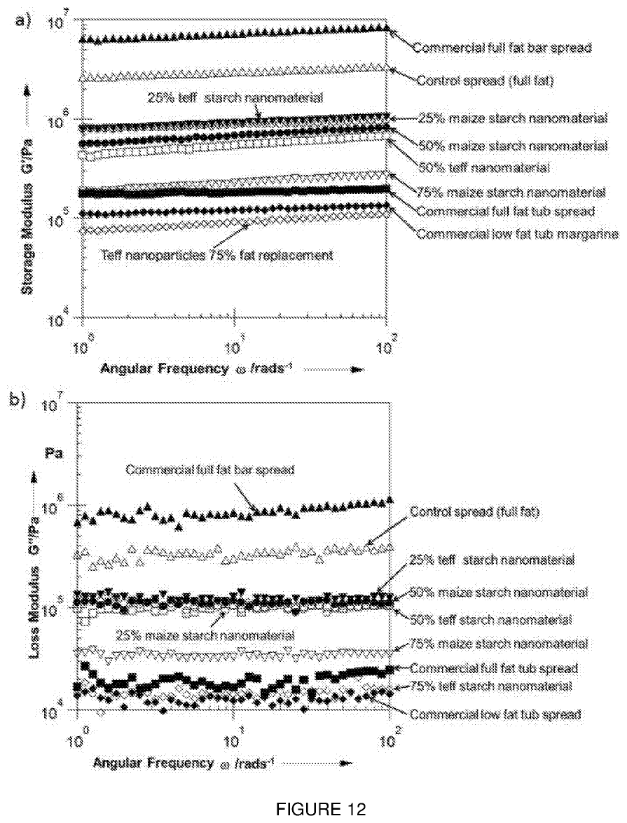

FIG. 12 shows the effect of oscillatory frequency on the storage (a) and loss (b) modulus of low-calorie spreads fat-replaced with aqueous dispersions of tef and maize starch nanomaterial compared to commercial spreads at 10° C.;

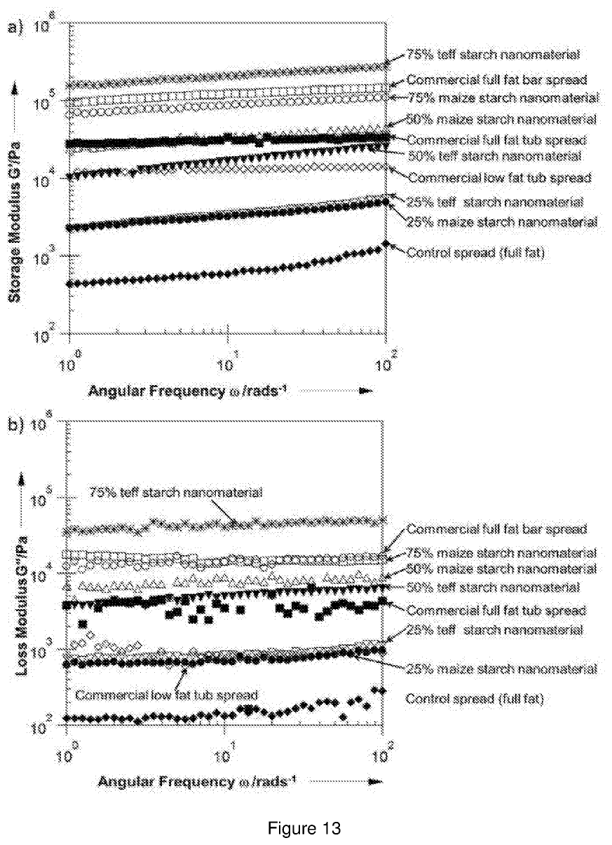

FIG. 13 shows the effect of oscillatory frequency on the storage (a) and loss (b) modulus of low-calorie spreads fat-replaced with aqueous dispersions of tef and maize starch nanomaterial compared to commercial spreads at 25° C.;

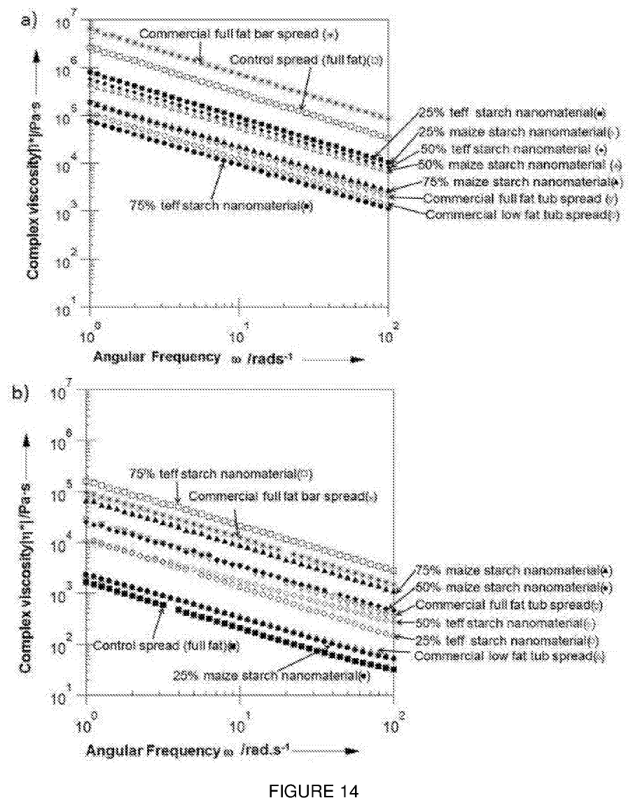

FIG. 14 shows the effect of oscillatory frequency on the complex viscosity of low-calorie spreads fat-replaced with aqueous dispersions of tef and maize starch nanomaterial compared to commercial spreads 10° C. (a) and 25° C. (b);

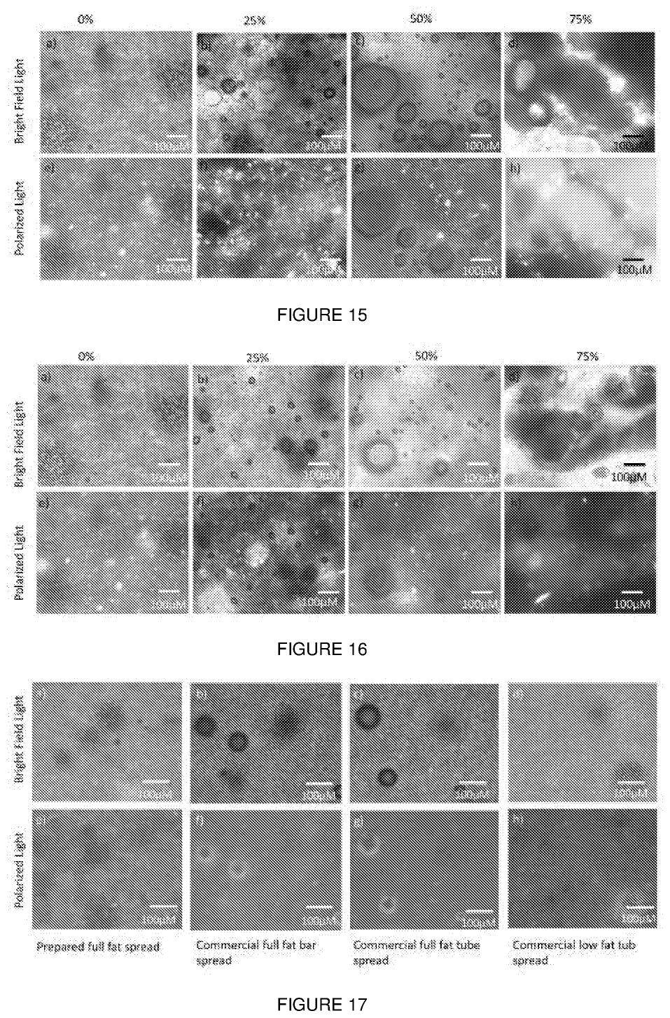

FIG. 15 shows Bright-field (a-d) and polarized (e-f) light optical microscopy images of prepared control fat spread (0%) replacement and tef starch nanomaterial fat-replaced spreads at 25, 50 and 75% w/w fat replacement;

FIG. 16 shows Bright-field (a-d) and polarized (e-f) light optical microscopy images of prepared control fat spread (0%) replacement and maize starch nanomaterial fat-replaced spreads at 25, 50 and 75% w/w fat replacement;

FIG. 17 shows Bright-field (a-d) and polarized (e-f) light optical microscopy images of prepared full fat spread (a), commercial full fat bar spread (b), commercial full fat tub spread (c), and a commercial low-fat tub spread (d);

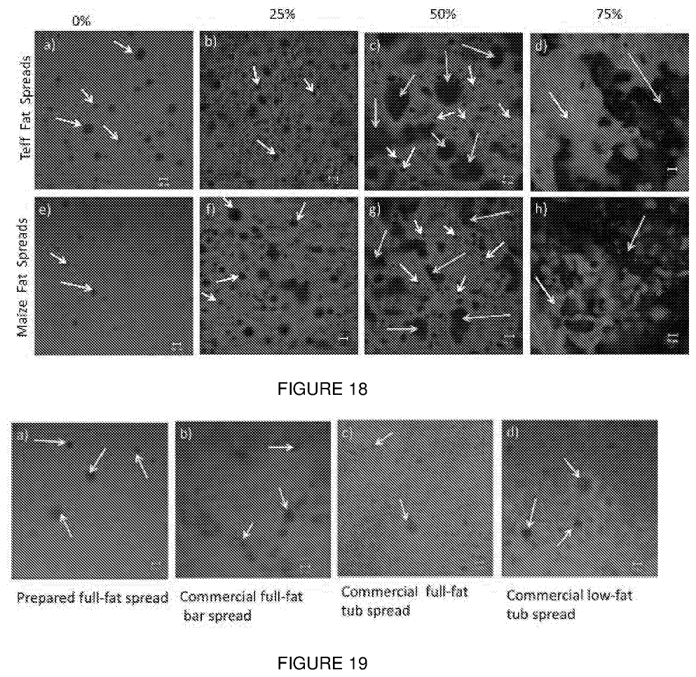

FIG. 18 shows confocal laser scanning images of prepared control fat spread (a-0% fat replacement)), tef (b-25, c-50, d-75% w/w) and maize (e-25, f-50, g-75% w/w) starch nanomaterial fat-replaced spreads; and

FIG. 19 shows confocal laser scanning images of a prepared full fat spread (a), and reference commercial full fat bar spread (b), commercial full fat tub spread (c), and commercial low-fat tub spreads (d).

### MATERIALS

Commercial white maize starch (Amyral©) was obtained from Tongaat Hulett (Edenvale, South Africa). Tef Starch was extracted from South African white tef (Pannar, Kronstad, South Africa) according to the method used by D'silva et al. (2011). The protein content of the tef and maize starch were 1.6% and 0.6% w/w (db) (N×6.25), respectively. The amylose content of the tef and maize starches determined according the method by Chrastil (1987) were 28.5 and 28.9%, respectively. Thermostable alpha-amylase from Bacillus licheniformis (EC.3.2.1.1, 3000 U/ml, lot no. 90201a) was obtained from Megazyme Ltd (Bray, Ireland). Stearic acid (analytical grade) was obtained from Sigma-Aldrich Company (St. Louis, Mo., USA).

### Methods

Isolation of Amylose-Stearic Acid Complex Structures from the Second Biphasic Peak Paste:

Amylose-stearic acid complexes were prepared by pasting maize or tef starch with added stearic acid for 130 min in an RVA followed by thermostable alpha-amylase hydrolysis of the resultant paste. Stearic acid (1.5% w/w) was incorporated in the tef starch and maize starch according to D'Silva et al., (2011). The starch-stearic acid mixture (10% w/w in distilled water) was then pasted by initially stirring at 960 rpm and 50° C. for 10 sec, heating to 90° C. at 10° C./min, and then holding for 130 min at 160 rpm. The RVA temperature was then immediately (approximately 30 seconds) adjusted to 75° C. and then thermostable alpha-amylase (0.5 ml, 0.375 U in Tris-HCI (0.05M, pH 8.2) buffer was added. Two different protocols were applied thereafter for isolation of the pasted starch residues at intervals of 0, 5 and 10 min during thermostable alpha-amylase hydrolysis. The unhydrolysed paste was considered to be at 0 min of hydrolysis. In the first protocol, the starch residues were isolated by rapidly dispersing the hydrolysed material in excess distilled (200 ml) water and then washing successively three times with distilled water. In the second protocol, the hydrolysed starch was rapidly dispersed in boiling acetate buffer (pH 3.5, 0.2 M, 95° C.) and then incubated at 95° C. for 20 min, before washing the starch residue three times with distilled water. Boiling the hydrolysed material in acetate buffer was done in order to inactivate the thermostable alpha-amylase (Linko and Linko, 1983). The tef and maize starch residues isolated, before or after acetate buffer treatment were then freeze-dried, and the yield determined as a percentage (% w/w) of the initially pasted starch weight.

### X-Ray Diffraction

The crystalline nature of the tef and maize starch residues isolated before or after acetate buffer treatment was investigated using XRD with an X'Pert PANanalytical diffractometer (Eindhoven, the Netherlands). The tef and maize starch residues isolated after thermostable alpha-amylase hydrolysis were gently ground to a fine powder (using laboratory mortor and pestle), and the moisture content equilibrated to 25.0% w/w at 25° C. in an equilibration chamber. The XRD operating conditions were; 45 kV, 40 mA and CuKα1 (0.154 nm). Scanning was done from 5 to 30° (2θ) with an exposure time of 16 min 14 s, step size of 0.026° and a time/step ratio of 229.5. The degree of crystallinity was determined as the percent integrated area of crystalline peaks to the total integrated area above the baseline (Cheetham and Tao, 1998b) using OriginPro® software version 7.5 (OriginLab, Northampton, Mass.).

### Differential Scanning Calorimetry

The thermal properties of the tef and maize starch residues, isolated before or after the acetate buffer treatment, were assessed in order to confirm the formation of V-amylose, determine the type of V-amylose formed, and evaluate the effect of hydrolysis on the stability of the V-amylose complexes. The properties were determined using a high pressure differential scanning system with Stare® software (HPDSC-827, Mettler Toledo, Greifensee, Switzerland). The tef and maize starch residues (5 mg) isolated before or after acetate buffer treatment after hydrolysis with thermostable alpha-amylase were mixed with distilled water (15 mg), and then equilibrated for at least 2 h at room temperature. Scanning was done from 40 to 145° C. at a rate of 10°/min with nitrogen at a flow rate of 100 ml/min and pressure of 40 bars. Indium (Tₚ=156.61° C., 28.45 J/g) was used as a standard, and an empty pan was used as a reference.

### Dynamic Light Scattering Particle Size Distribution

The particle size distribution of the tef and maize starch residues isolated before or after the acetate buffer treatment was determined using a Horiba LB-550 (Tokyo, Japan), dynamic light scattering system. The isolated tef and maize starch residues (0.1 g) were dispersed in distilled water (5 ml), and 5 drops of the suspension added to distilled water (2 ml) in a glass cuvette. The distribution was measured based on length distribution, with an ethanol refractive index and viscosity of 1.36 and 1.13×10⁻³ Pa·s (1.13 cP), respectively. A starch refractive index of 1.53 for the nanoparticle starch complexes was used (Wang, Li, Wang, Chiu, Chen and Mao, 2008). At least six independent distributions were combined for each sample and the average particle size determined.

### AFM

The surface morphology of the tef and maize starch residues isolated before or after the acetate buffer treatment was determined using a Nanoscope IVa AFM (Veeco, N.Y., USA). The AFM was operated in the tapping mode at room temperature with a silicon cantilever having a maximum tip diameter of 10 nm. The samples (0.1 g) were dispersed in absolute ethanol (2 ml) and sonicated (30 sec, 25° C.). The resultant suspensions were vacuum spin coated on a glass slide, dried in a forced convention oven at 45° C. for 2 h and then observed at room temperature with a scan rate of 0.5 Hz over a scan area of 0.5×0.5 μm using 512 lines per sample. Height and phase images were taken in order to identify and exclude artefacts due to interaction of the cantilever and the sample during interpretation (Hoper, Gesang, Possart, Hennemann and Boseck, 1995).

### HRTEM

The high resolution structure of the tef and maize starch residues isolated before or after the acetate buffer treatment was assessed using a JEM-2100 TEM system (JEOL Ltd, Tokyo, Japan). The isolated tef and maize starch residues (0.1 g) were suspended in absolute ethanol by sonication for 30 sec at 25° C. and then a drop deposited on a Holey 300 mesh carbon-coated copper grid (Agar scientific, Standsted, England). The samples were dried at room temperature for 2 h, and then observed at 100-800 k magnification with 200 kV. The HRTEM images obtained were analysed for particle size distribution using ImageJ® software (National Institute of Health, Md., USA).

### Results

### Percentage Yield of Isolated tef and Maize Starch Residues

The percentage yield of the tef starch residues isolated before acetate buffer treatment significantly (p≤0.05) decreased with hydrolysis time from 75.4% w/w to 52.2% w/w and then to 30.2% w/w at 0, 5 and 10 min, respectively (see Table 1).

The yield of the maize starch residues isolated before acetate buffer treatment also significantly (p≤0.05) decreased from 74.4% to 44%, and then to 29.8% at 0, 5 and 10 min, respectively (see Table 1). After acetate buffer treatment, the percentage yield of tef and maize starch residues also significantly (p≤0.05) decreased with hydrolysis time. Tef starch residue yields decreased from 78.7% to 25.7% and then to 18.6% while the maize starch residues decreased from 76.3% to 23.6% and then to 16.6% at 0, 5 and 10 min, respectively (see Table 1). The starch molecule breakdown leads to shorter and more water soluble dextrins and maltodextrins which can be removed through washing with distilled water (Chronakis, 1998). The reduction in the percentage residue yield with hydrolysis time for the tef and maize starch residues isolated before or after acetate buffer treatment was, therefore, probably due to increased breakdown of starch molecules in the starch pastes.

The percentage residue yields after hydrolysis for the tef and maize starch residues isolated with acetate buffer at 5 min of hydrolysis were 25.69% and 23.61%, respectively, while those for the tef and maize starch residues isolated without acetate buffer treatment after 10 min of hydrolysis were 30.23% and 29.82%, respectively. These values were close to the amylose contents (approximately 29%) of the tef and maize starch samples that were used. For that reason, we believe that the residues isolated at 5, and 10 min after and before acetate buffer treatment probably consisted of the amylose component of the pasted starches which was complexed with the added stearic acid. The residues probably consisted of little or no amylopectin since amylopectin does not form complexes with ligands because it's linear sections (≈Dp 20) are not long enough to form the helical complex structures (minimum required ≈Dp 30) (Eliasson et al., 1988; Godet et al., 1995a). The probable presence of mainly the stearic acid-complexed amylose in the residues isolated at 5 and 10 min after and before acetate buffer treatment, respectively, supported by reports which demonstrated that complexed components of starches are more resistant to alpha-amylase hydrolysis than uncomplexed components (Biais et al., 2006; Gelders et al., 2005a; Godet et al., 1996; Heinemann et al., 2005; Holm et al., 1983; Jane and Robyt, 1984; Seneviratne and Biliaderis, 1991). This implies that the hydrolysis process from the beginning up to the particular times of 5 and 10 min possibly involved the uncomplexed amylopectin component of the starches without affecting the amylose component.

TABLE 1
Effect of hydrolysis time on the percentage yield of tef and maize starch
residues isolated before or after acetate buffer treatment.

| | Isolated Starch Recovery | | |
|---|---|---|---|
| Treatment | 0 min hydrolysis | 5 min hydrolysis | 10 min hydrolysis |
| Before acetate buffer | | | |
| treatment | | | |
| Tef starch | 75.4 ± 2.1e | 52.2 ± 3.3d | 30.2 ± 3.8b |
| Maize starch | 74.4 ± 3.3e | 44.1 ± 3.9c | 29.8 ± 2.2b |
| Acetate buffer treatment | | | |
| Tef starch | 78.7 ± 5.3e | 25.69 ± 2.5b | 18.6 ± 1.4a |
| Maize starch | 76.3 ± 5.1e | 23.6 ± 3.1b | 16.6 ± 2.2a |

The starches were pasted for 130 min at 90° C. with added stearic acid before thermostable alpha-amylase hydrolysis at 75° C..
Tabulated values are weight/weight percentages based on the initially pasted starch weight.
Values with different letters in each column or row are significantly different (p ≤ 0.05).
Tabulated values are means of at least 3 independent experiments.

The tef and maize starch residue recovery percentages observed after thermostable alpha-amylase hydrolysis for the samples isolated before or after acetate buffer treatment were higher than those reported by Kim and Lim (2009) and Kim et al. (2009) who reported values of <10% after hydrolysis of starch-butanol complexes from native starch (non-dextrinized). In another study, though a recovery percentage of 50% w/w weight of the starting material (starch dextrins) was reported (Kim and Lim, 2010). In these different studies, however, the nanoparticle starch-butanol complexes were obtained after a relatively long time of at least 7 days and using a non-food compatible solvent (butanol). In the present study, the isolated material was obtained from native starch (rather than starch dextrins) in <3 h of preparation using a food system compatible ligand (stearic acid) and solvent (distilled water).

The higher hydrolysis temperature of 75° C. in the present study enabled faster hydrolysis of the starch by the thermostable alpha-amylase compared to previous studies that carried hydrolysis of complexed starch at 25° C. using porcine pancreatic amylase (Kim and Lim, 2009; Kim and Lim, 2010; Kim et al., 2009). The shorter preparation time in the present study was also facilitated by the starch biphasic pasting procedure applied in the present study which was shown to result into crystalline amylose-stearic acid complexes after 2 h of pasting in a rapid visco-analyser (Wokadala et al., 2012a). In previous studies reported elsewhere on production of starch nanoparticle complexes, the complex formation was the rate limiting step (longest time taken at this stage in the process) and took up to 6 days (Kim and Lim, 2009; Kim and Lim, 2010; Kim et al., 2009).

### Crystalline Structure and Crystallinity of Isolated tef and Maize Starch Residues Using X-Ray Diffraction

The crystalline characteristics of the tef and maize starch residues isolated before or after acetate buffer treatment that followed hydrolysis with thermostable alpha-amylase at 75° C. for 0, 5 and 10 min are shown in FIG. 1. The tef and maize starch residues isolated before acetate buffer treatment demonstrated three major peaks at D-spacings 1.19, 0.68 and 0.45 nm (see FIGS. 1a and b respectively). On the other hand, the tef and maize starch residues isolated after acetate buffer treatment had major peaks at D-spacings 1.21, 0.95, 0.74, 0.69, 0.63, 0.53, 0.49, 0.45, 0.42 and 0.40 nm (see FIGS. 1c and d respectively). FIG. 1 shows X-ray diffractograms of isolated tef and maize starch residues after hydrolysis with thermostable alpha-amylase hydrolysis at 75° C. for 0, 5 and 10 minutes.

The starches were pasted in the RVA for 130 min at 90° C. before hydrolysis.

There was a significant (p≤0.05) increase in relative crystallinity with hydrolysis time for the tef and maize starch residues isolated before or after acetate buffer treatment. The relative crystallinity of the tef starch residues isolated before acetate buffer treatment significantly (p≤0.05) increased with hydrolysis time from 18.3% to 52.4% and then to 53.7% while that for maize starch increased from 26.7% to 32.1% and then to 53.3% at 0, 5 and 10 min, respectively (see Table 2).

The crystallinity of tef starch residues isolated after acetate buffer treatment also significantly (p≤0.05) increased with hydrolysis time from 39.3% to 49.0% and then to 57.7% for 0, 5 and 10 min, respectively (see Table 2). The relative crystallinity of maize starch residues isolated with acetate buffer treatment significantly (p≤0.05) increased too from 35.7% to 47.3% and then to 53.4% at 0, 5 and 10 min, respectively (see Table 2).

TABLE 2
Effect hydrolysis time on the relative crystallinity of isolated tef and
maize starch residues after hydrolysis with thermostable alpha-amylase hydrolysis at
75° C. for 0, 5 and 10 minutes.

| | Hydrolysis time/Min | | |
|---|---|---|---|
| Treatment | 0 min | 5 min | 10 min |
| Before acetate buffer treatment | | | |
| Tef starch | 18.3 ± 2.9a | 52.4 ± 2.0c | 53.7 ± 2.3c |
| Maize starch | 26.7 ± 2.8b | 32.1 ± 0.7a | 53.3 ± 5.7c |
| Acetate buffer treatment | | | |
| Tef starch | 39.3 ± 1.7c | 49.0 ± 2.6b | 57.7 ± 4.9c |
| Maize starch | 35.7 ± 3.1c | 47.3 ± 3.4b | 53.4 ± 3.0c |

The starches were pasted for 130 min at 90° C. before or after added stearic acid.
Values with different letters in each row are significantly different (p ≤ 0.05).

The XRD patterns for the tef and maize starch residues before acetate buffer treatment (see FIGS. 1a and b) have been assigned to type V6I-amylose lipid complexes (also known as Vh complexes) (Hinkle and Zobel, 1968; Le Bail et al., 2005; Rappenecker and Zugenmaier, 1981; Zobel et al., 1967). The observed XRD pattern of the tef and maize starch residues isolated before acetate buffer treatment was in accordance with recent results reported elsewhere which showed that tef and maize starch pasted under similar conditions consists of V-amylose-lipid complexes (Wokadala et al., 2012a). On the other hand, based on the observed peaks, the XRD patterns for the tef and maize starch residues isolated after acetate buffer treatment (see Table 2c and d) have been assigned to form Type V6II-amylose lipid complexes (Helbert and Chanzy, 1994; Jouquand, Ducruet and Le Bail, 2006; Le Bail et al., 2005). Both the V6I and V6II amylose-lipid complexes are made up of 6-fold left-handed single helices with helix pitch diameter of 0.8 nm (Helbert and Chanzy, 1994; Rappenecker and Zugenmaier, 1981). The helices in V6II amylose-lipid complexes are arranged in slightly larger three dimension units (a=2.74 nm, b=2.65 nm, c=0.8 nm) which can accommodate lipid/ligand molecules in the interhelical spaces (Helbert and Chanzy, 1994) compared to V6I amylose-lipid complexes (a=1.36 nm, b=2.37 nm, c=0.8 nm) (Rappenecker and Zugenmaier, 1981) that has no ligands between the helices.

Alpha-amylase hydrolysis of starch that contains amylose-lipid complexes is believed to occur in the amorphous component which leads to an increase in relative crystallinity (Gelders et al., 2005a; Gelders et al., 2004; Godet et al., 1996; Jane and Robyt, 1984; Seneviratne and Biliaderis, 1991). The increased relative crystallinity hydrolysis time in the present study for the tef and maize starch residues isolated before or after acetate buffer treatment, therefore, indicated a reduction in the amorphous component of the starches and an increase in the relative proportion of the crystalline component. The increase in relative crystallinity was in accordance with research which reported that the crystallinity of starch that contains amylose-lipid complexes increases with alpha-amylase hydrolysis (Gelders et al., 2005a; Godet et al., 1996; Kim and Lim, 2009; Kim et al., 2009).

### Thermal Properties of Isolated tef and Maize Starch Nano-Particles by Differential Scanning Calorimetry (DSC)

There was no significant (p≤0.05) difference in the onset (To), peak (Tp) and endset (Te) transition temperature values of the residues isolated at the different hydrolysis times (0, 5 or 10 min) for tef and maize starch residues purified before (see Table 3) or after (see Table 4) acetate buffer treatment. All the tef and maize starch residues isolated before or after added acetate buffer treatment at the different hydrolysis times (0, 5, 10 min) had peak transition temperatures (Tp) values greater than 104° C. (see Table 3 and 4).

The Tp of both the tef and maize starch residues isolated before acetate buffer treatment were significantly (p≤0.05) lower than those of the samples isolated after acetate buffer treatment. Tef starch residues isolated before acetate buffer treatment had Tp values of 109.5, 108.0° C. and 107.6° C. while that isolated after acetate buffer treatment had values of 113.6, 111.8° C. and 115.5° C. after 0, 5, and 10 min of hydrolysis, respectively (see Table 3 and 4) respectively. Maize starch residues isolated before acetate buffer treatment had Tp values of 105.7, 105.9° C. and 108.7° C. while that isolated after acetate buffer treatment had values of 111.2, 112.3° C. and 110.0° C. after 0, 5, and 10 min of hydrolysis, respectively (see Table 3 and 4 respectively).

Amylose-lipid complexes with Tp greater than 104° C. are considered as Type II V-amylose lipid complexes (Biliaderis and Galloway, 1989; Biliaderis and Seneviratne, 1990; Tufvesson and Eliasson, 2000; Tufvesson et al., 2003a). In the present study, the tef and maize starch residues isolated before or after acetate buffer treatment were, therefore, made up of Type II V-amylose-stearic acid complexes.

The melting enthalpy (ΔH) of the tef starch residues isolated before acetate buffer treatment after thermostable alpha-amylase hydrolysis significantly (p 0.05) increased with hydrolysis time from −1.6 J.g⁻¹ at 0 min to −3.7 J·g⁻¹ and −5.7 J·g⁻¹ at 5 and 10 min, respectively (see to Table 3). The melting enthalpy (ΔH) of the maize starch residues isolated before acetate buffer treatment after thermostable alpha-amylase hydrolysis increased from −2.0 J·g⁻¹ at 0 min to −4.1 J·g⁻¹ and −4.4 J·g⁻¹ at 5 and 10 min, respectively (see Table 4).

TABLE 3
Thermal characteristics of tef and maize starch residues isolated before
acetate buffer treatment

| | Melting Temperatures and Enthalpy | | | |
|---|---|---|---|---|
| Sample | Onset (To)/° C. | Peak (Tp)/° C. | Endset (Te)/° C. | Δ H (J.g⁻¹) |
| Tef starch | | | | |
| 0 min | 106.4 ± 0.2a | 109.5 ± 0.1b | 112.8 ± 0.1c | −1.6 ± 0.1a |
| 5 min | 102.8 ± 1.4a | 108.0 ± 0.3b | 111.3 ± 0.4c | −3.7 ± 0.2b |
| 10 min | 100.8 ± 0.1a | 107.6 ± 0.1b | 112.6 ± 0.6c | −5.7 ± 0.5d |
| Maize starch | | | | |
| 0 min | 100.7 ± 6.4a | 105.7 ± 5.1b | 111.7 ± 5.7c | −2.0 ± 0.1a |
| 5 min | 99.5 ± 3.3a | 105.9 ± 2.2b | 111.7 ± 0.4c | −4.1 ± 0.4b |
| 10 min | 99.7 ± 4.8a | 108.7 ± 0.8b | 114.8 ± 1.4c | −4.4 ± 0.5c |

*The starches were pasted in the RVA for 130 min at 90° C. before hydrolysis.
The pastes were hydrolysed with thermostable alpha-amylase at 75° C. for 0, 5, and 10 min.
Values with different letters in each column are significantly different (p ≤ 0.05).

The melting enthalpy (ΔH) of the tef starch residues isolated after acetate buffer treatment after thermostable alpha-amylase hydrolysis significantly (p≤0.05) increased with hydrolysis time from −1.4 J·g⁻¹ at 0 min to −5.2 J·g⁻¹ at 5 min. The enthalpy of −5.1 J·g⁻¹ at 10 min was not significantly different from that at 5 min of hydrolysis (see to Table 3). The ΔH of the maize starch residues isolated after acetate buffer treatment following thermostable alpha-amylase hydrolysis increased from −2.2 J·g⁻¹ at 0 min to −7.8 J·g−¹ and −8.4 J·g⁻¹ at 5 and 10 min, respectively (see Table 4).

TABLE 4
Thermal properties of tef and maize starch residues isolated after acetate buffer
treatment

| Sample | Melting Temperatures and Ethalpy | | | |
|---|---|---|---|---|
| Tef starch | Onset (To)/° C. | Peak (Tp)/° C. | Endset (Te)/° C. | Δ H (J.g⁻¹) |
| 0 min | 109.6 ± 0.7a | 113.6 ± 0.3b | 117.7 ± 1.4c | −1.4 ± 0.1a |
| 5 min | 107.9 ± 0.2a | 111.8 ± 0.4b | 116.5 ± 0.5c | −5.2 ± 0.2b |
| 10 min | 111.4 ± 4.9a | 115.5 ± 4.9b | 120.3 ± 5.2c | −5.1 ± 0.2b |
| Maize starch | | | | |
| 0 min | 103.2 ± 0.1a | 111.2 ± 0.5b | 127.3 ± 0.2c | −2.2 ± 0.1a |
| 5 min | 108.2 ± 4.0a | 112.3 ± 1.9b | 118.9 ± 2.5c | −7.8 ± 1.0c |
| 10 min | 106.5 ± 3.2a | 110.7 ± 0.5b | 121.8 ± 6.9c | −8.4 ± 1.3c |

The starches were pasted in the RVA for 130 min at 90 °C. before hydrolysis.
The pastes were hydrolysed with thermostable alpha-amylase at 75° C. for 0, 5, and 10 min.
Values with different letters in each column are significantly different (p ≤ 0.05).

The amorphous component of starch that contains crystalline amylose-lipid complexes is more susceptible to alpha-amylase hydrolysis compared to the crystalline component (Gelders et al., 2005a; Godet et al., 1996; Jane and Robyt, 1984; Seneviratne and Biliaderis, 1991) (Heinemann et al., 2005). The increases in melting enthalpy (ΔH) observed in the present study with increased hydrolysis time, therefore, probably resulted from the removal of the more amorphous component of the starch. The increase in the ΔH values was also supported by the XRD results which showed increased relative crystallinity with increased hydrolysis time. Similar findings showing an increase in ΔH with increased enzymatic hydrolysis time were also observed during the isolation of nanoparticle V-amylose complexes containing butanol through pancreatic alpha-amylase hydrolysis by (Kim and Lim, 2009).

When starch that contains amylose-lipid complexes is heated at high temperatures (about 90° C.) in low pH conditions, there is an increase in the formation of more ordered (crystalline) amylose-lipid complexes (Karkalas and Raphaelides, 1986; Zabar et al., 2009a). The formation of more ordered structures is suggested to result from thermal annealing effects on the amylose-lipid complexes (Lalush et al., 2005; Zabar et al., 2009a; Zabar et al., 2009b). This is demonstrated in the present study by the generally higher ΔH values observed for the tef and maize starch residues isolated after acetate buffer treatment (pH 3.5, 95° C., 20 min) compared to those of the residues isolated before acetate buffer treatment (see Table 4). For the DSC results (Table 3 and 4), the higher enthalpies for the acetate buffer treated samples compared to the non-acetate buffer treated samples were however, less clear for tef starch compared to maize starch. However, the higher crystalline order in the acetate buffer treated samples compared to the non-acetate buffer treated samples, was more clearly illustrated by the higher crystallinity values obtained from XRD for both tef and maize starch (see Table 2).

### Particle Size Distribution of the Isolated tef and Maize Starch Residues Using Dynamic Laser Scattering Particle Size Analysis

The particle size distribution for tef and maize starch residues isolated before or after acetate buffer treatment that followed thermostable alpha-amylase hydrolysis are shown in FIG. 2. The particle size for tef starch residues isolated before acetate buffer treatment had a mean of 6.5±1.6 (range=2.9-15.0) nm, 6.8±2.1 (range=2.6-17.1) nm and 7.1±2.5 (range=4.4-11.4) nm at 0, 5 and 10 min, respectively (see FIG. 2a). The particle size for maize starch residues isolated before acetate buffer treatment has a mean of 6.0±2.7 (range=1.7-19.6) nm, 7.28±3.0 (range=2.9-22.5) nm, and 8.3±4.2 (range=4.4-17.1) nm at 0, 5 and 10 min, respectively (see FIG. 2b).

The particle size, on the other hand, decreased with increasing hydrolysis time for both tef and maize starch residues isolated after acetate buffer treatment (see FIG. 2). The particle size of tef starch residues isolated after acetate buffer treatment decreased from a mean of 83.3±35.3 (range=38.7-296.2) nm, to 61.9±20.5 (range=29.5-225.8) nm, then to 55.3±10.8 (range=33.8-100.0) nm at 0, 5 and 10 min, respectively. The particle size of maize starch residues isolated after acetate buffer treatment decreased from 95.1±38.0 (range=44.3-296.2) nm, to 57.7±15.2 (range=25.7-225.8) nm, then to 49.7±15.2 (range=22.5-114.5) nm for maize starch residues isolated after acetate buffer treatment at 0, 5 and 10 min, respectively. For the ranges, the highest detected value was indicated as the upper range limit while the lowest detected value was recorded as the minimum value. For FIG. 2, after the mean value, the population density of some samples (e.g. 2a, 5 min) could have been zero before the maximum value. This explains the apparently lower upper range limit on the graph (e.g. in FIG. 2a the upper limit apparently is <15 nm while the actual detected upper value is 17.1 nm). The relatively high standard divisions are typical of the laser scattering particle size distribution method. Similar standard deviation values have been reported for amylose-lipid complexes nanoparticles by Lesmes et al. (2009).

The particles observed in the present study, for the tef and maize starch residues isolated before acetate buffer treatment were smaller than the amylose-butanol V-complex nanoparticles obtained by Kim and Lim (2009) (ranged from 28-51 nm), using a dynamic laser scattering particle size analyser. The particle size distribution observed in the present study for the tef and maize starch residues isolated after acetate buffer treatment were within the range that was reported by Kim and Lim (2009). The particle size distributions obtained for the samples isolated after acetate buffer treatment in the present study were also practically within the range of 40-225 nm observed by Lesmes et al. (2009) for non-hydrolysed V-amylose complexes containing stearic, linoleic or linolenic acid although a lower particle size mean was observed in the present study.

Amylose-lipid complexes have been suggested to consist of crystalline lamella regions that have dimensions of about 10 nm or less (Godet et al., 1996; Jane and Robyt, 1984; Seneviratne and Biliaderis, 1991). The particle size distribution range of the particles isolated before acetate buffer treatment (refer to FIG. 2) falls within this size range. The size of amylose-lipid complex crystalline structures has been suggested to increase during alpha-amylase hydrolysis (Heinemann et al., 2005). The enzymatic hydrolysis is suggested to facilitate aggregation of amylose-lipid complex helices to form larger aggregates (Heinemann et al., 2005) (FIG. 2.2.10, section 2.2.4.1). The slight increase in the mean particle size with hydrolysis time for the tef and maize starch particles isolated before acetate buffer treatment could probably have resulted from slight aggregation of helices induced by hydrolysis. FIG. 2 shows the particle size distribution of tef and maize starch residues isolated before or after acetate buffer treatment following thermostable alpha-amylase hydrolysis at 75° C. for 0, 5, and 10 minutes. The starches were pasted in the RVA for 130 min at 90° C. before hydrolysis

On the other hand, heating of amylose-lipid complexes under conditions of low pH is suggested to result into increased precipitation and aggregation of amylose-lipid complexes (Karkalas et al., 1995; Karkalas and Raphaelides, 1986). The larger particle size (about 4 times larger) of the particles isolated after acetate buffer treatment, therefore, probably results from precipitation of V-amylose during acetate buffer treatment.

### Surface Morphology of tef and Maize Starch Residues Isolated Before or After Acetate Buffer Treatment Using AFM

The non-hydrolysed (0 min) tef and maize starch complexes isolated without acetate buffer treatment consisted of a mixture of small distinct particles and large relatively non-distinct areas (refer FIGS. 3 and 4 respectively) shown by AFM images.

The large non distinct areas apparently cleared with increased hydrolysis time at 5 min of hydrolysis for both tef and maize starch residues isolated without acetate buffer treatment. With extended hydrolysis (10 min), distinct round/ovoid flattened nanomaterial structures, were observed for both tef and maize residues isolated before acetate buffer treatment (refer FIGS. 3 and 4 respectively). The tef isolated at 10 min of hydrolysis before acetate buffer treatment had particle sizes in the range of about 5.3-22.9 nm (n=70) with an average height of about 4.5 nm. The maize nanomaterial isolated at 10 min of hydrolysis before acetate buffer treatment had particle sizes in the range of about 5.2-31.6 nm (n=85) with an average height of about 4.3 nm. The particle size ranges for the distinct regions observed with AFM, for the tef and maize starch residues isolated before acetate buffer treatment, were within the corresponding ranges obtained using dynamic laser scattering particle size distribution, see previous discussion.

FIG. 3 shows AFM 2-dimension height and phase images tef starch residues isolated before acetate buffer treatment after thermostable alpha-amylase hydrolysis at 75° C. for 0, 5, and 10 minutes. The starches were pasted in the RVA for 130 min at 90° C. before hydrolysis. Horizontal line at the bottom of phase images is scale bar=2000 nm Bold white arrows indicate non-physically separated (non-distinct) areas. Bold black arrows indicate physically separated (distinct) areas.

FIG. 3 shows AFM 2-dimension height and phase images maize starch residues isolated before acetate buffer treatment after thermostable alpha-amylase hydrolysis at 75° C. for 0, 5, and 10 minutes. The starches were pasted in the RVA for 130 min at 90° C. before hydrolysis. Horizontal line at bottom of phase images is scale bar=2000 nm. Bold white arrows indicate non-physically separated (non-distinct) areas. Bold black arrows indicate physically separated (distinct) areas.

The tef and maize starch complexes isolated with acetate buffer heating treatment also showed relatively non-distinct matrices apparently mixed with distinct nanomaterial at 0 min of hydrolysis (refer to FIGS. 5 and 6 respectively). With increased hydrolysis time at 5 min, the tef and maize starch complexes isolated after acetate buffer treatment showed distinct flattened round/ovoid shaped structures with little non-distinct material (refer to FIGS. 5 and 6 respectively). The tef nanomaterial isolated after acetate buffer treatment at 5 min of hydrolysis had estimated particle sizes of about 23.5-218.1 nm (n=70) with an average height of about 4.4 nm. Maize nanomaterial isolated after acetate buffer treatment at 5 min of hydrolysis had estimated particle sizes of about 26.3-165.7 nm (mean=65.5, n=70) with a height of about 4.7 nm, respectively hydrolysis (refer to FIGS. 5 and 6 respectively).

The average elevation (height) of the distinct nanomaterial isolated before or after acetate acid treatment observed using AFM in the present study was similar to that reported elsewhere for distinct starch nanomaterials containing complexed stearic acid (Lesmes et al., 2009). The nanoparticles isolated both before or after acetate buffer treatment in the present study were however smaller (diameter) than those (180 nm) observed in amylose-stearic acid complexes (Lesmes et al., 2009). The particles isolated before or after acetate buffer treatment in the present study were also smaller than those observed in amylose-lipid complexes produced with water/DMSO solutions at 90° C. by Lalush et al. (2005). On the other hand, the particles isolated after acetate buffer treatment in the present study had similar diameter to the globular structures of about 60±8 nm and 152±39 nm observed for amylose-lipid complexes prepared using KOH/HCI and water/DMSO solutions respectively at 90° C. that were observed by Lalush et al. (2005).

FIG. 4 shows atomic force microscopy 2-dimension height and phase images tef starch residues isolated after acetate buffer treatment after thermostable alpha-amylase hydrolysis at 75° C. for 0, 5, and 10 minutes. The starches were pasted in the RVA for 130 min at 90° C. before hydrolysis. Horizontal line at bottom of phase images is scale bar=2000 nm. Bold white arrows indicate physically separated (distinct) areas. Bold black arrows indicate non-physically separated (non-distinct) areas.

FIG. 5 shows AFM 2-dimension height and phase images maize starch residues isolated after acetate buffer treatment after thermostable alpha-amylase hydrolysis at 75° C. for 0, 5, and 10 minutes. The starches were pasted in the RVA for 130 min at 90° C. before hydrolysis. Horizontal line at bottom of phase images is scale bar=2000 nm. Bold white arrows indicate physically separated (distinct) areas. Bold black arrows indicate non-physically separated (non-distinct) areas.

### Morphology and Particle Size Distribution of Isolated Nano-Particle Complexes Using HRTEM.

The structure of tef and maize starch residues isolated before or after acetate buffer treatment after hydrolysis with thermostable alpha-amylase at 75° C. for 0, 5, and 10 min is shown in FIG. 7. The tef and maize starch complexes isolated, before acetate buffer treatment, consisted mainly of non-physically separate (non-distinct) regions at 0 min of hydrolysis (refer to FIGS. 6a and b respectively). The non-physically separate (non-distinct) regions apparently cleared with increased hydrolysis time at 5 min of hydrolysis (see FIGS. 6e and f). The non-distinct regions were almost completely removed at 10 min of hydrolysis (see FIGS. 6i and j) to reveal nanoparticle structures made up of distinct irregularly shaped randomly oriented nanoparticle structures for both tef and maize starch, respectively. The nanoparticle structures observed were estimated to have Feret's diameters ranging from 3-10 nm for tef starch and 2.4-6.7 nm for maize (see FIGS. 6i and j respectively). The apparent stacking of the nanomaterial structures observed could have been expected since stacking of nanomaterial can occur during drying (Kim and Lim, 2009; Kim et al., 2009).

The tef and maize starch complexes isolated after acetate buffer heating treatment also showed non-distinct matrices at 0 min of hydrolysis (see FIGS. 6c and d respectively). With increased hydrolysis time at 5 min of hydrolysis, the tef and maize starch complexes isolated with acetate buffer treatment showed distinct (physically separate) regularly shaped circular to ovoid structures with almost no non-distinct matrix surrounding them (see FIGS. 6g and h respectively). These nanoparticles isolated after acetate buffer treatment at 5 min of hydrolysis had estimated particle Ferret's diameters of about 6.2-64.7 nm (n=50) for maize starch and about 6.1-94 nm (n=65) for tef starch. With further hydrolysis at 10 min the tef and maize starch isolated after acetate buffer treatment, the physically separate (distinct) structures apparently broke down into a mass of packed irregular shaped to non-distinct structures (FIGS. 6j and k respectively).

Apparently the nanoparticles isolated without acetate buffer treatment observed under the HRTEM were slightly smaller than those observed with AFM. This is probably because the AFM method is a surface technique and uses a tapping cantilever (10 nm tip) which may not clearly distinguish shapes of smaller particles (<10 nm) unlike the HRTEM method which involves transmitting electrons through the sample. For tapping mode in air, deep areas (trenches) of <10 nm in samples may not be clearly detected by 10 nm cantilevers (Solares, 2008).

The physically separate (distinct) tef and maize starch nanomaterial isolated after thermostable alpha-amylase before or after acetate buffer treatment consisted of crystalline regions as observed by the First Fourier Transform (FFT) of the electron diffraction image (see inset bottom-right, FIGS. 6f, g, h, i). The crystalline nature of the distinct particles can also be inferred through the lamellae-like structures that aligned in the same direction in the nanoparticle (see FIGS. 6f, g, h, i). There were some apparently amorphous regions, however, in some of the isolated nanoparticles (see FIGS. 6f, g, h and i). These regions can also be interpreted to result from an arrangement of the crystalline regions in such a manner that they were not in diffraction condition with the incident electron beam while hence appearing amorphous, while well aligned appeared crystalline. The stacking of the nanoparticles can be considered a normal phenomenon since the analysis was carried out on dried samples (Kim and Lim, 2009).

FIG. 6 shows high HRTEM images of tef and maize starch paste residues isolated before (a,b,d,e,h,i) and after (c,d,f,g,j,k) acetate buffer treatment that followed hydrolysis of second biphasic pastes with thermostable alpha-amylase at 75° C. for 0, 5, and 10 minutes. The starches were pasted in the RVA for 130 min at 90° C. to obtain the complexes before hydrolysis. Arrows in (f), (g), (h) and (i) indicate individual starch-stearic acid nanoparticles as indicated by the crystal lamellae arranged in the same direction. Bold black arrows indicate distinct nanostructures/regions; blue arrows indicate non-distinct matrix; red arrows indicated non-distinct/non-physically separated matrix/regions. The scale bar is represented by the black line below the scale value.

The mean particle sizes of the nanoparticles isolated before acetate buffer treatment were comparable to the 1.6-4.5 nm crystals thickness dimension observed by Godet et al., (1996) using HRTEM but were smaller than the 10-20 nm nanoparticles observed by Kim and Lim (2009). The particles isolated with acetate buffer treatment, on the other hand, were within the range reported by Kim and Lim (2009) although they apparently had a wider range of distribution. In the present research, the difference in size of the nanoparticle complexes isolated before and after acetate buffer treatment was because acetate buffer treatment isolation protocol probably accelerated the hydrolysis with acetate buffer treatment. This is supported by the fact that distinct crystalline nanoparticles were observed at 5 min of hydrolysis (see FIGS. 6f, g, h and i) for the samples isolated with acetate buffer treatment compared to 10 min of hydrolysis for the isolation without acetate buffer treatment. The accelerated hydrolysis is also apparently supported by the lower recovered residues percentage at 5 min for the samples isolated after acetate buffer treatment compared to those isolated without acetate buffer treatment (see Table 1).

The crystalline component of starch that contains amylose-lipid complexes is more resistant to enzymatic and acid hydrolysis compared to the amorphous component (Biais et al., 2006; Gelders et al., 2005a; Godet et al., 1996). During alpha-amylase hydrolysis of V-amylose complexes, the amorphous component of the starch is hydrolysed first before the crystalline component (Jane and Robyt, 1984; Seneviratne and Biliaderis, 1991). In the present study, the appearance of distinct nanoscale structures after hydrolysis for both the sample isolated before or after acetate buffer treatment was, therefore, due to removal of the amorphous matrix surrounding the crystalline components. With the extended hydrolysis (10 min), the physically separated (distinct) nanomaterial obtained at 5 min of hydrolysis after acetate buffer treatment could have disintegrated leaving the observed apparently non-physically separated (non-distinct) (FIGS. 5j and k).

The larger size of the distinct nanomaterial observed using HRTEM for the samples isolated after acetate buffer treatment compared to those isolated before acetate buffer treatment were in accordance with dynamic laser scattering particle size distribution (see previous discussion) and the AFM results (see previous discussion). As stated before, heating amylose-lipid complexes under conditions of low pH (90° C.) promotes precipitation of amylose-lipid complexes (Karkalas et al., 1995; Karkalas and Raphaelides, 1986) and also results into an annealing effect on the amylose-lipid complexes formed (Lalush et al., 2005; Zabar et al., 2009a; Zabar et al., 2009b). We therefore believe that, in the present study, the larger particles observed under HRTEM for the tef and maize samples isolated after acetate buffer treatment resulted from a combined effect of annealing and precipitation due to the low pH heating conditions.

The tef and maize starch nanomaterial isolated in the present study before and after acetate buffer treatment at 5 and 10 min of hydrolysis respectively were similar in shape (ovoid/circular to irregularly shaped) to those isolated by Kim and Lim (2009). The nanomaterial isolated after acetate buffer treatment, however, apparently had more regular round to ovoid structures compared to those observed by Kim and Lim (2009). Other different distinct nanomaterial shapes have been shown to exist in amylose-lipid complexes in some other studies using TEM. Rectangular shaped nanoparticles of >200 nm were observed by Kim and Lim (2010) while Putaux, Cardoso, Dupeyre, Morin, Nulac and Hu (2008) suggested that square units of 50-100 nm were occurred in rectangular micron scale amylose-lipid complexes structures. It is suggested that factors that affect amylose-lipid complexes structure at nanoscale are diverse and are yet to be clearly understood (Wokadala, Ray Sinha and Emmambux, 2012b). The difference in the shapes of the distinct nanoscale structures under TEM in the different studies therefore arises from the differences in the specific complex preparation methods in the different studies.

It can be concluded from the above that nanoparticle starch-stearic acid V-amylose complexes have been isolated from tef and maize starch using RVA pasting of starch in the presence of added stearic acid (corresponding to the second biphasic peak viscosity paste) followed by high temperature thermostable alpha-amylase hydrolysis. The resultant nanomaterial has V6I and V6II-amylose lipid complex crystal types for the materials isolated before and after acetate buffer treatment. The tef and maize starch nanomaterial isolated before or after inactivation of the thermostable alpha-amylase using acetate buffer treatment have been observed to contain Type II V-amylose nanoparticles. PSD, AFM, HRTEM showed the isolated material to consist of particulate nanomaterials at 5 min and 10 min for the material isolated with and without acetate buffer treatment, respectively. The nanomaterial has been obtained in a relatively short time (about 3 h) with relatively high yields (>23%) and using food system compatible solvents and ligands. The present research shows that different nanostructures and types of V-amylose complexes can be produced from tef and maize starch modified with stearic acid by treatment with and without acetate buffer treatment. This could be applied for preparation of V-Amylose nanostructures suitable for specific applications.

### Use of Amylose-Lipid Complexes as a Fat Replacer in Foodstuffs

### Materials

Tef Starch was extracted from South African white tef (Whitkop, Pannar, Kronstad, South Africa) according to the method used by D'silva et al. (2011). Commercial white normal maize starch (Amyral®) was obtained from Tongaat Hulett (Edenvale, South Africa). The protein content of the tef and maize starch were 1.6% and 0.6% (db) (N×6.25), respectively. Thermally stable alpha-amylase from Bacillus licheniformis (EC.3.2.1.1, 3000 U/ml) was obtained from Megazyme Ltd (Bray, Ireland). Stearic acid (analytical grade) was obtained from Sigma-Aldrich Company (St. Louis, Mo., USA). A commercial fat blend was obtained from Hudson and Knight (Boksburg, South Africa). The fatty acid composition of the commercial fat blend is given in Table 5. Distilled monoglyceride emulsifier (Dimodan®) was obtained from Danisco (Copenhagen, Denmark). Commercial full fat (80% w/w total fat) tub spread, commercial full fat (80% w/w total fat) bar spread, and commercial low fat (35% total fat) tub spread were obtained from a local supermarket.

TABLE 5
Fatty acid composition* of the commercial fat blend used for
preparation of fat spreads for fat replacement with isolated tef
and maize starch nanomaterial.

| Fatty acid | Percentage (% w/w) |
|---|---|
| Caprylic | 0.3 |
| Capric | 0.3 |
| Lauric | 4.3 |
| Myristic | 2.3 |
| Palmitic | 33.0 |
| Palmitoleic | 0.1 |
| Stearic | 4.5 |
| Oleic | 34.5 |
| Linoleic | 20.0 |
| Alpha-linoleic | 0.4 |
| Eicosenoic | 0.2 |
| Docosanoic | 0.2 |
| Tetracosanoic acid | 0.1 |

*Values were determined by fat blend supplier using gas chromatography

### Methods

### Preparation of tef and Maize Starch Nanomaterial

Tef and maize starch nanomaterial were prepared as described above through pasting of tef and maize starch with added stearic acid followed by thermostable alpha-amylase hydrolysis for 5 min and then acetate buffer treatment.

### Preparation of Fat-Replaced Spreads Using Aqueous Dispersions of tef and Maize Starch Nanomaterial

The low-spreads were prepared by mixing an aqueous phase containing tef or maize nanomaterials with a fat blend based on the method by Clegg, Moore and Jones (1996). Commercial spreads (low fat tub spread, full fat tub and bar spreads) were used as reference samples. The aqueous phase was prepared by mixing the tef or maize starch nanomaterial (15% w/w) with distilled water at 40° C. The emulsifier was solubilized by melting about 5 g of the commercial fat blend at 70° C. and then adding the emulsifier (Dimodan®) with homogenizing at 8000 rpm. The fat blend component containing the emulsifier was then cooled to 40° C. and then added to the rest of the fat blend at 40° C. The aqueous phase was added at a rate of about 5 g per min with homogenization at 8000 rpm for 10 min. The mixture (15 g) was transferred to a rheometer (Anton Paar Physica MCR 101® Rheometer, Germany) with a holding cell and shuttle mixer. The material was cooled from 40 to 5° C. at a rate of 6°/min with stirring at 800 rpm for 10 seconds and then 400 rpm for 6 min. The mixture was worked at 5° C. for 30 min with stirring at 550 rpm. The semi-solid mixture was then stored at 5° C. overnight in order to obtain the full fat and low-calorie spreads. Tests were performed on the spread within 72 h of preparation. The tef and maize starch nanomaterial fat replacement levels in the spreads were at levels of 0, 25, 50 and 75% w/w of the total fat according to Table 4.3.2. Potassium sorbate and the emulsifier (Dimodan®) were used at 0.1% and 0.3% w/w respectively for all the low-calorie spreads.

TABLE 6
Composition of prepared low-calorie spreads fat-replaced with aqueous
dispersions of tef and maize starch nanomaterial.

| | Fat replacement level (% w/w)* | | | |
|---|---|---|---|---|
| Components | 0 | 25 | 50 | 75 |
| Aqueous phase | | | | |
| Distilled water | 19.9 | 33.9 | 50.9 | 67.9 |
| Potassium sorbate | 0.1 | 0.1 | 0.1 | 0.1 |
| Tef or Maize starch | 0 | 6.0 | 9.0 | 12.0 |
| nanomaterial | | | | |
| Fat Phase | | | | |
| Distilled monoglyceride | 0.3 | 0.3 | 0.3 | 0.3 |
| (Dimodan ^{®}) | | | | |
| Fat Blend | 79.7 | 59.7 | 39.7 | 19.7 |

*Full fat spread/margarine is considered to consist of 80% w/w fats (Chrysan, 2005). At the indicated fat replacement levels, therefore, fat-replaced spreads correspond to 80, 60, 40, and 20% w/w total fat for 0, 25, 50 and 75% fat replacement, respectively.

Textural Properties of the Low-Calorie Spreads Fat-Replaced with Aqueous Dispersions of tef and Maize Starch Nanomaterial

The textural characteristics of the low-calorie spreads fat-replaced with aqueous dispersions of tef or maize starch nanomaterial and those of the reference commercial spreads were determined based on the method by Liu, Xua and Guo (2007) with modification. An EZtest texture analyser (Shimadzu, Kyoto, Japan) with a 50 N load cell was used. A Perspex cone bob (45°, upper diameter=30 mm, height=40 mm) with cylindrical sample holding tub (internal diameter=18 mm, external diameter=20 mm, height=10 mm) were used. The sample (about 5 g) was filled in the tub and the surface levelled off with a flat spatula. The samples were then equilibrated at 15° C. for 2 h before textural measurements. The cone bob was lowered into the sample starting at about 2.5 mm above the sample at speed of 50 mm/s and 5 mm/s when in the sample. The bob penetrated the sample to a distance of 5 mm and then was retracted at a rate of 10 mm/s to 2.5 mm outside the sample. The firmness (maximum positive force), stickiness/cohesiveness (maximum negative force), penetration energy (positive area) and adhesiveness (negative area) of the spreads was determined from the resulting force-time curves (Liu et al., 2007).

Viscoelastic Properties of the Spreads Fat-Replaced with Aqueous Dispersions of tef and Maize Starch Nanomaterial

The linear viscoelastic properties of the low-calorie spreads and those of the reference commercial spreads were determined using an Anton Paar Physica MCR 101® rheometer (Germany) equipped with a peltier heating system. A parallel plate system (plate diameter=25 mm) with a serrated upper plate for preventing slippage was used (Laia, Ghazalia, Cho and Chong, 2000).

### Amplitude Sweep

An amplitude sweep was performed at 30° C. on the low-calorie spreads and the reference commercial spreads in order to determine their linear viscoelastic (LVE) range. A portion (about 5 g) of the sample was placed on the lower plate pre-set at 25° C., and then the upper plate lowered to a gap distance of 1 mm. Excess sample was scrapped off the edges using a spatula and then the sample equilibrated for 20 min before measurement. The strain sweep was done from 0.001-100% at a frequency of 6.28 rads/s (1 Hz). The storage modulus (G′) was recorded and the limit strain of the linear viscoelastic range determined. All the samples were found to have a linear viscoelastic range limit of 0.05-0.5%. Therefore, a strain of 0.01% was then used for the subsequent measurements for all samples.

### Temperature Sweep

A temperature sweep at a frequency of 6.28 rads/s (1Hz) over the range 5-30° C. at a rate of 3°/min for the all the low-calorie spreads and the reference samples were done. A portion of the sample (about 2 g) was placed on the lower plate pre-set at 5° C. The upper plate was lowered immediately and then excess sample scraped from the edges using a spatula. A gap distance of 1 mm was used. The sample was then equilibrated for 20 min before taking the measurements with a strain of 0.01%. The G′ was measured and recorded. The meltability of the samples was determined from the temperature sweep as the slope of the storage modulus according to Cheng, Lim, Chow, Chong and Chang (2008). The meltability (slope) was determined using the power law model (Eqn. 1) as applied by (Shukla and Rizvi, 2006).

G′=G′ₒT^{A} Eqn 1

where, G′ is the storage modulus at temperature T; G′ₒ is the initial storage modulus value at T=20° C.; and A is the power law index (meltability index).

### Frequency Sweep

The frequency sweep of the low-calorie spreads and the commercial reference samples was done at 10° C. and 25° C. using the parallel plate system mentioned above (amplitude sweep section). A portion of the sample was placed on the lower plate, and then the serrated upper plate lowered to the measuring position (gap=1 mm). Excess sample was removed from the edges using a spatula and then the sample equilibrated at the measuring temperature for 20 min. Measurements were done over the range 0.1-100 rad/s with a strain of 0.01%. The strain level used was within the LVE of all the samples according to preliminary amplitude sweep experiments. The G′ and the loss (G″) modulus plus the complex viscosity (η*) were measured and recorded.

### Bright-Field (BFOM) and Polarized Light Optical Microscopy (POM)

Plain BFOM and POM of the low-calorie spreads and the commercial reference spreads was done using a Nikon Optiphot compound microscope (Nikon, Tokyo, Japan) at a magnification of ×20 for all the samples at 25° C. A portion of the sample was placed on a graduated microscope slide and then a cover slip applied gently on the surface of the sample. The samples were viewed in the bright-field mode, and then a polarizer placed on the condenser and turned until the maximum polarization point (darkest field point). A picture of the same view was taken in both the bright-field and polarized light mode using a Nikon DXM 1200 digital camera (Nikon, Tokyo, Japan) with Nikon ACT software.

### Con Focal Laser Scanning Microscopy (CLSM)

The microscopic structure of the low-calorie spreads and the commercial reference spreads were assessed using a Zeiss LSM 510 META confocal laser scanning microscope (Zeiss SMT, Jena, Germany). The fat-replaced spreads were prepared as stated in section with an aliquot (0.1 ml per 50 g of sample) of Nile red (0.01% w/v) added to the fat phase to enable staining of the fats. A small amount of the sample (about 1.0 g) was placed in a concave microscope slide, covered with a cover slip and then observed with an excitation and emission wavelength of 488 nm and 668-753 nm respectively at 25° C. Plane neoflar 100× and numerical aperture (N.A) 1.4 was used. The pixel time for both tracks 1 and 2 was 12.8 μs, and the picture taken was 512×512 pixels.

### Characteristics of the Isolated tef and Maize Nanomaterial Used for Fat Replacement

HRTEM images showed that the tef and maize starch materials isolated for replacement of fat in the spreads consisted of nano-sized particles of diameters of about 16.6-95.7 nm and 11.7-105.0 nm respectively (refer to FIG. 8). DSC showed that the isolated material they had To (melting start transition temperature), Tp (peak transition temperature), and Te (end transition temperature) values of 114.8, 118.9° C. and 124.0° C., respectively, for tef starch while maize starch had values of 111.0, 113.7° C. and 120.7° C., respectively. These values were also in accordance with the values reported in previous sections and these complexes have been assigned to Type II amylose-lipid complexes as previously discussed. FIG. 8 shows HRTEM images of isolated tef (a) and maize (b) nanomaterial. The bold white arrows indicated individual nanoparticles.

### Textural Properties of Spreads

The texture profiles of the low-calorie spreads and the reference commercial spreads are shown in FIG. 9. The corresponding derived values of firmness (maximum positive force), stickiness/cohesiveness (maximum negative force), penetration energy (positive area) and adhesiveness (negative area) are presented in Error! Reference source not found.7. FIG. 9 shows textural profiles of spreads fat-replaced with aqueous dispersions of tef and maize starch nanomaterial compared to reference commercial full fat and low spreads. Commercial low and full fat spreads consisted of 35% and 80% w/w total fat. Fat replacement at 0, 25, 50 and 75% corresponds to 80, 60, 40 and 20% w/w total fat.

The firmness, stickiness and penetration energy of the low-calorie spreads significantly (p≤0.05) increased with increased fat replacement with the tef or maize starch nanomaterial aqueous dispersions. On the other hand, the adhesiveness significantly (p≤0.05) decreased with increased fat replacement using both the tef and maize starch nanomaterial aqueous dispersions (refer to Table 7). The commercial full-fat bar spread had the highest (p≤0.05) values of firmness, stickiness, penetration energy and adhesiveness while the commercial low fat spread had the lowest values (refer to FIG. 9 and Table 7). The values of firmness, stickiness, penetration energy, and adhesiveness for the low-calorie spreads (at 25, 50, and 75% w/w fat replacement) were comparable to those for commercial full fat bar spread and the low-fat spread (refer to Table 7).

In particular, at 25% w/w fat replacement, stickiness, penetration energy and adhesiveness of the low-calorie spreads with both tef and maize starch nanomaterial were not significantly (p>0.05) different from those of the commercial full fat tub spread. Firmness and penetration energy have been shown to correlate with sensory perception of spreadability of spreads (Glibowski, Zarzycki and Krzepkowska, 2008; Pompei, Lucisano, Zanoni and Casiraghi, 1988). The lower the firmness and penetration energy, the higher the spreadability of a given spread product (Glibowski et al., 2008; Pompei et al., 1988). The firmness and penetration values of the low-calorie spreads fat-replaced with both tef and maize nanomaterial aqueous dispersions were within the range of those for the commercial spreads (see Table 7). The spreadability of the low-calorie spreads fat-replaced with tef or maize nanomaterial aqueous dispersions was therefore probably within commercial acceptable limits.

TABLE 7
Effect of added aqueous dispersions of tef and maize starch nanomaterial on the textural parameters of low-calorie
spreads

| Fat replacement | | Textural properties | | | |
|---|---|---|---|---|---|
| level % w/w * | Added material | Firmness/N | Stickiness/N | Penetration enemy/J | Adhesivness/N |
| 0 | Distilled water | 0.35 ± 0.06f | −0.13 ± 0.00b | 8.96 ± 1.18f | −1.72 ± 0.20b |
| 25 | Tef nanomaterial | 0.51 ± 0.01e | −0.16 ± 0.00b | 11.48 ± 0.37f | −2.15 ± 0.08b |
| | Maize nanomaterial | 0.30 ± 0.01f | −0.12 ± 0.01b | 7.06 ± 0.37f | −1.82 ± 0.24b |
| 50 | Tef nanomaterial | 0.70 ± 0.06d | −0.23 ± 0.01d | 16.38 ± 2.62d | −2.29 ± 0.25b |
| | Maize nanomaterial | 0.55 ± 0.05e | −0.19 ± 0.01d | 13.39 ± 1.51d | −2.06 ± 0.44b |
| 75 | Tef nanomaterial | 2.02 ± 0.08b | −0.33 ± 0.02f | 45.20 ± 2.49b | −0.97 ± 0.18a |
| | Maize nanomaterial | 1.14 ± 0.07c | −0.26 ± 0.03e | 22.11 ± 2.14c | −1.77 ± 0.24b |
| 65** | Commercial low fat spread | 0.18 ± 0.02g | −0.07 ± 0.01a | 4.28 ± 0.62g | −1.01 ± 0.02a |
| 0 | Commercial full fat tub spread | 0.39 ± 0.01f | −0.13 ± 0.00b | 8.73 ± 0.52f | −1.93 ± 0.17b |
| 0 | Commercial full fat bar spread | 2.84 ± 0.16a | −1.14 ± 0.07g | 75.41 ± 6.10a | −6.69 ± 0.98c |

tests were done at least in triplicates
* Commercial full fat and low spread = 80% and 35% w/w total fat respectively.
**Commercial that total fat in commercial low fat spread is reduced by 65% of normal margarine which contains 80% total fat
Values with different letters in the same column are significantly (p ≤ 0.05) different.

### Viscoelastic Properties

### Temperature Sweep of the Spreads

At the start of the temperature sweep (5° C.), the G′ decreased significantly (p≤0.05) with increasing fat replacement in the order 0>25>50>75% w/w. At the end of the temperature sweep (30° C.), G′ increased with increasing fat replacement in the order 75>50>25>0% w/w (refer to FIGS. 10a and b). FIG. 10 shows the effect of temperature on G′ of low-calorie spreads fat-replaced with tef (a) and maize (b) starch nanomaterial aqueous dispersions and commercial (low and full fat) reference spreads. Commercial low and full fat spreads consisted of 35% and 80% w/w total fat. Experiments were done at 0.01% strain and frequency of 6.28 rads/s (1 Hz) and a heating rate of 3°/min.

Other studies on fat replacement in high-fat food systems with hydrocolloids have also shown that the resultant low-calorie products maintain a relatively high G′ compared to non-fat-replaced samples during temperature sweeps (Borwankar, Frye, Blaurock and Sasevich, 1992; Chronakis and Kasapis, 1995b; Singh and Byars, 2011). In order to assess the role played in maintaining the G′ by the aqueous dispersions of tef and maize starch nanomaterial, temperature sweeps from −5-70° C. were performed in aqueous dispersions of the nanomaterials under the same conditions as those of the sweep performed on the low calorie spreads. The results (refer to FIG. 11), indicated that the aqueous dispersions the tef and maize starch nanomaterial had relatively constant G′ within the range −5-70° C. This probably explained why high G′ values were maintained with increased fat replacement. In addition, the high G′ of the low calories spread with increased fat replacement could also have been enabled by the fact that the crystallites in the tef and maize starch nanomaterial have melting temperatures in the range of 110-120° C. FIG. 11 shows the effect of temperature on storage and loss modulus of aqueous dispersions of tef and maize starch nanomaterial. Experiments were done at 0.01% strain and frequency of 6.28 rads/s (1 Hz) and a heating rate of 3°/min. Aqueous dispersions were prepared at 15% w/w concentration. A thin film of silicon oil was applied on the edges of the samples in order to avoid moisture evaporation.

The G′ of the spreads showed two main regions during the temperature sweep. The first region was characterized by a relatively stable or slow decrease in G′ and occurred in the temperature range of about 5-15° C. (refer to FIGS. 10a and b). The second region was characterized by a relatively rapid decrease in G′ and occurred in the range of about in 15-30° C. (refer to FIGS. 10a and b). According to Vithanage, Grimson and Smith (2009), the first region is considered as the solid-like phase while the second phase can be considered as the spreadable phase. In the present research, the spreadable phase started at a higher temperature (about 20° C.) for the commercial spreads compared to prepared low-calorie spreads with tef starch nanomaterial (refer to FIG. 10).

The G′ of spreads during a temperature sweep can be affected by the fatty acid composition of the fat blend used, the cooling time-temperature profile, and the storage time of the spread (Goli, Sahri, Kadivar and Keramat, 2009; Laia et al., 2000; Zhang, Jacobsen, Pedersen, Christensen and Adler-Nissen, 2006). Therefore, the higher starting temperature of the spreadable phase for the commercial spreads was probably due to the fatty acid profile of the fat blend and preparation conditions used that could have been different from those of the low-calorie spreads.

Meltability is an important parameter in determining the release of flavours and acceptability of spreads (Borwankar et al., 1992). The slope of the G′ during a temperature sweep is considered to be an indicator of the meltability of spreads (Cheng et al., 2008; Rønn, Hyldig, Wienberg, Qvist and Laustsen, 1998). In the present research the slope was estimated according to Shukla and Rizvi (2006) by fitting the data to a power law model. The G′ was defined by the power law model with R²-values in the range 0.879-0.997 (refer to Table 8).

The slope decreased significantly (p≤0.05) with increased fat replacement for the low-calorie spreads with both tef and maize starch nanomaterial (refer to Table 8). The meltability of the spreads, therefore, decreased with increased tef or maize starch nanomaterial addition. However, the meltability of low-calorie spreads fat-replaced at 25% with tef or maize nanomaterial aqueous dispersions was not significantly (p≤0.05) different from that of the commercial low-fat and full fat tub spreads (refer to Table 8).

TABLE 8
Effect of added aqueous dispersions of tef starch nanomaterial
fat replacement level on the textural properties of spreads.

| Fat replacement | | Meltability | R²- |
|---|---|---|---|
| level (% w/w) * | | (Pa/° C.) | value |
| 0 | Distilled water (Control) | −6.90 ± 0.82c | 0.929 |
| 25 | Tef nanomaterial | −8.68 ± 0.92d | 0.996 |
| | Maize nanomaterial | −7.91 ± 0.34d | 0.997 |
| 50 | Tef nanomaterial | −3.84 ± 0.28b | 0.961 |
| | Maize nanomaterial | −4.25 ± 0.12b | 0.951 |
| 75 | Tef nanomaterial | −1.75 ± 0.09a | 0.955 |
| | Maize nanomaterial | −1.54 ± 0.13a | 0.946 |
| 65 | Commercial low fat spread | −8.12 ± 0.79d | 0.942 |
| 0 | Commercial full fat tub spread | −9.36 ± 0.38 | 0.973 |
| 0 | Commercial full fat bar spread | −8.40 ± 0.21d | 0.879 |

The replacement levels of 0, 25, 50, and 75% w/w correspond to 80, 60, 40, and 20% w/w total fat of the spread.
Commercial full fat and low spread = 80% and 35% w/w total fat respectively.
Values with different letters in the same column are significantly (p ≤ 0.05) different.

### Frequency Sweep of the Spreads

During frequency sweep, the G′ of the low-calorie and commercial reference spreads was significantly (p≤0.05) higher than G″at both 10° C. (refer to FIG. 12) and 25° C. (refer to FIG. 13). When G′>G″, a sample is considered to have a more solid-like character compared to a liquid-like character that occurs when G″>G′ (Mezger, 2006; Tabilo-Munizaga and Barbosa-Canovas, 2005). The viscoelastic character can be expressed as a ratio G″/G′, which is referred to as tan δ. A given material can be considered liquid-like, at the gel point, and solid-like when tan δ>1, tan δ=1, and tan δ<1 respectively (Mezger, 2006; Tabilo-Munizaga and Barbosa-Canovas, 2005). The spreads were, therefore, solid-like at both 10° C. (refer to FIG. 12) and 25° C. (refer to FIG. 13). However, the low-calorie spreads and the commercial spreads at 25° C. had a significantly (p≤0.05) higher tan δ of about 0.15-0.35 compared to about 0.07-0.13 for the spreads at 10° C. which indicated a more solid-like character. These results are in accordance with Chronakis and Kasapis (1995b), who showed that spreads with added hydrocolloids for producing low-calorie spreads can maintain a solid-like (tan δ<1) character during a temperature sweep up to 70° C.

At 10° C., the G′ and G″ significantly (p≤0.05) decreased with increased fat replacement in the order 25>50>75% for the low-calorie spreads fat-replaced with both tef and maize nanomaterial aqueous dispersions (refer to FIG. 12). However, at 25° C. the G′ and G″ significantly (p≤0.05) increased with increased fat replacement in the order 25<50<75% for both the low-calorie with tef and maize starch nanomaterial (refer to FIG. 13). FIG. 12 shows the effect of oscillatory frequency on the storage (a) and loss (b) modulus of low-calorie spreads fat-replaced with aqueous dispersions of tef and maize starch nanomaterial compared to commercial spreads at 10° C. Commercial low and full fat spreads consisted of 35% and 80% w/w total fat. Experiments were done at 0.01% strain and frequency of 6.28 rads/s (1Hz) and a heating rate of 3°/min. FIG. 13 shows the effect of oscillatory frequency on the storage (a) and loss (b) modulus of low-calorie spreads fat-replaced with aqueous dispersions of tef and maize starch nanomaterial compared to commercial spreads at 25° C. Commercial low and full fat spreads consisted of 35% and 80% w/w total fat. Experiments were done at 0.01% strain and frequency of 6.28 rads/s (1 Hz) and a heating rate of 3°/min.

The complex viscosity also significantly (p≤0.05) decreased with increased fat replacement up to 75% at 10° C. but increased with a higher fat replacement (75%) with both tef and maize nanomaterial aqueous dispersions at 25° C. (refer to FIG. 14). These findings were in accordance with the temperature sweep which showed that the low-calorie spread maintained a higher G′ at the end of the temperature sweep with increased fat replacement (5-30° C.). FIG. 14 shows the effect of oscillatory frequency on the complex viscosity of low-calorie spreads fat-replaced with aqueous dispersions of tef and maize starch nanomaterial compared to commercial spreads 10° C. (a) and 25° C. (b). Commercial low and full fat spreads consisted of 35% and 80% w/w total fat. Experiments were done at 0.01% strain and frequency of 6.28 rads/s (1Hz) and a heating rate of 3°/min.

However, at 10° C. and 25° C., the G′ and G″ for the low-calorie spreads fat-replaced with both tef and maize starch nanomaterial at 25 and 50% w/w were within the range of the commercial reference spreads (refer to FIGS. 12 and 13). The G′ and G″ of the low-calorie spreads with tef and maize starch nanomaterial did not significantly (p>0.05) change during the frequency sweep at both 10° C. and 25° C. (refer to FIGS. 12 and 13). The storage and loss modulus of the low-calorie and reference commercial spreads was, therefore, apparently independent of the frequency of oscillation. Similar curves showing frequency independence of G′ and G″ of spreads have been reported by other researchers (Chronakis, 1998; Laia et al., 2000). The relatively constant storage and loss modulus with increased oscillation frequency in the present study probably implied that the rate of shear does not affect the structure of the low-calorie spreads as suggested by Shukla and Rizvi (2006). This behaviour is generally referred to as a pseudo solid-like behaviour. Frequency independence of both G′ and G″ over the frequency sweep range with G′>G″ indicated that the spreads consisted of a three dimensional gel structure that consisted of a well-organized network of the spread components (Funami, Yada and Nakao, 1998).

On the other hand, the complex viscosity (η*) decreased with increased frequency at both 10° C. and 25° C. for both the low-calorie spreads and the commercial spreads (see FIGS. 14a and b respectively). Decrease in viscosity with increased shear rate (frequency) is characteristic of shear thinning materials whose structure is apparently destroyed under high shear force (Tabilo-Munizaga and Barbosa-Cánovas, 2005). Spreadable butter systems have also been shown to have shear thinning properties (Rousseau, Hill and Marangoni, 1996; Shukla and Rizvi, 2006). Shear thinning is an important property of the spreads as it indicates that the spreads can be spread when pressure is applied (Lai, Ghazali, Cho and Chong, 1999).

According to De Man (1990), the viscoelastic and rheological properties of margarines (high fat spreads, 80% w/w fat) results from a three dimensional network of fat crystals. The bonds that hold fat crystals together to form a three dimensional network include; irreversible primary covalent bonds that are formed within the fat crystals during crystal growth and reversible van der Waal's forces that hold crystals together (De Man, 1990). The rheological properties of margarine type spreads are governed by the amount of fat crystals present, the size of fat crystals present and the strength of the intra- and extra-crystal bonds (De Man, 1990). In the present study, the reduction in margarine fat content through fat replacement probably led to a decrease in the amount of fat crystals. The viscoelastic and rheological properties of the resultant low-calorie spreads were hence probably affected due to fewer structure holding fat crystals compared to the non-fat-replaced margarine.

The spatial distribution of fat droplets/crystals in a flocculated structure (such as aggregated fatty acid crystals is spread) and the strength of the attractive forces between them determine the viscoelastic properties of flocculated gels (Mcclements, 1998). Therefore, with increased fat replacement with the aqueous dispersions of the tef and maize starch nanomaterial, there probably was a decrease in the van der Waal's forces that held the fat crystals together. This reduction probably resulted from an increased spatial space between the fat crystals due to the presence of the increased amounts of aqueous dispersions of the tef and maize starch nanomaterial. A decrease in the extent of fat droplet/crystal flocculation will decrease the viscosity for a given system (Mcclements and Demetriades, 1998). This probably also explains the observed decrease in complex viscosity (FIG. 14). The decreased strength of Van de Waal's forces and decreased fat crystal flocculation also probably explains the decrease in elastic and loss modulus with increased fat replacement at 10° C. (FIG. 12).

### Effect of Fat Replacement Using Aqueous Dispersions of tef and Maize Starch Nanomaterial on the Bright-Field Optical and Polarized Light Microscopic Structure of the Low-Calorie Spreads

Few or no distinct structures (round dark regions) were observed under bright-field optical microscopy (BFOM) for the control spreads (0% fat replacement) although small evenly distributed bright specks were observed under polarized optical microscopy (POM) (see FIGS. 15a, e and 16a, e for tef and maize respectively). The bright specks observed in POM probably correspond to crystal structures of the fat phase (Norizzah, Chong, Cheow and Zaliha, 2004; Saadi, Ariffin, Ghazali, Abdulkarim, Boo and Miskandar, 2012). At 25% fat replacement with aqueous dispersions of tef (FIG. 15b) and maize (see FIG. 16b) starch nanomaterial, BFOM showed some evenly distributed distinct round areas of about 30.4-120.6 μm. Similar regions were observed under POM although there were bright specks covering or surrounding them in the low-calorie spreads fat-replaced with aqueous dispersions of tef (FIG. 15e) and maize (FIG. 16e) starch nanomaterial.

At 50% fat replacement level, distinct non-evenly distributed regions of up to 500 μm were observed under BFOM for both the spreads fat-replaced with aqueous dispersions of tef (FIG. 15c) and maize (FIG. 16c) starch nanomaterials. The bright specks observed under POM were apparently separated from the less bright regions for both the spreads fat-replaced at 50% level with aqueous dispersions of tef (FIG. 15g) and maize (FIG. 16g) starch nanomaterials. At 75% fat replacement level, there were continuous dark regions and continuous clear regions under BFOM for both the spreads fat-replaced with aqueous dispersions of tef (FIG. 15d) and maize (FIG. 16d) starch nanomaterial. Continuous bright and dark regions were also observed under POM for the spreads fat-replaced with aqueous dispersions of tef (FIG. 15h) and maize (FIG. 16h) starch nanomaterials. These BFOM and POM observations probably indicated higher phase separation at 75% fat replacement. FIG. 15 shows BFOM (a-d) and POM (e-f) images of prepared control fat spread (0%) replacement and tef starch nanomaterial fat-replaced spreads at 25, 50 and 75% w/w fat replacement. FIG. 16 shows BFOM (a-d) and POM (e-f) images of prepared control fat spread (0%) replacement and maize starch nanomaterial fat-replaced spreads at 25, 50 and 75% w/w fat replacement.

BFOM and POM observations also showed that the microstructure of the prepared full fat spread (FIG. 17a) was similar to that of the commercial reference samples (refer to parts b to h of FIG. 17). The observed contrast in BFOM and POM structure between the commercial low fat spread (FIGS. 17d and h) and the prepared low-calorie spreads (FIGS. 17d and h) probably resulted from difference in ingredients and preparation conditions as explained above for CLSM. FIG. 17 shows BFOM (a-d) and POM (e-f) images of prepared full fat spread (a), commercial full fat bar spread (b), commercial full fat tub spread (c), and a commercial low-fat tub spread (d).

### Effect of Fat Replacement Using Aqueous Dispersions of tef and Maize Starch Nanomaterial on the Confocal Laser Scanning Microscopic Structure of the Low-Calorie Spreads

At 0% fat replacement (control with added distilled water), the prepared spreads consisted of a continuous mass stained red and with few regular round regions of about 10.1-72.5 μm that were not stained by the Nile red (indicated by white bold arrows in FIGS. 18a and e).

The stained area consists of the fat phase while the regular non-stained (darker) areas consist of the aqueous phase (Clegg et al., 1996; Van Dalen, 2002). These regions could not be identified clearly for the control spread (0% fat replacement) under BFOM and POM because the methods could not distinguish them based on their properties such as the stain binding used in CLSM. At 25% w/w fat replacement level with the addition of the aqueous dispersions of both the tef (FIG. 18b) and maize (FIG. 18f) starch nanomaterials, the population density of the regular round unstained (darker) regions increased. The dimensions (about 12.3-70.4 μm) of the unstained regions in the low calorie spreads with 25% fat replacement were, however, within the range of those observed in the control spread with 0% fat replacement. FIG. 18 shows confocal laser scanning images of prepared control fat spread (a-0% fat replacement)), tef (b-25, c-50, d-75% w/w) and maize (e-25, f-50, g-75% w/w) starch nanomaterial fat-replaced spreads. Scale bars on the bottom right corners=50μm. The red stained material is the fat phase while the dark unstained component is the aqueous phase. Bold white arrows indicate non-stained relatively regularly shaped regions. Bold greed arrows indicate non-stained larger relatively irregular regions.

At 50% fat replacement (FIGS. 15c and g), large non-distinct regions of about 57.1-213.2 μm (green arrows) were observed, in addition to the regular round regions observed at 0 and 25% fat replacement. The larger relatively irregular regions in the present study were apparently due to a coalescing of the small regular aqueous phase regions which indicated the initiation of phase separation (Van Dalen, 2002). The spreads fat-replaced at 75% fat replacement (FIGS. 18d and h) showed continuous irregular regions stained with Nile red and continuous dark irregular (unstained) regions. The presence of continuous unstained and stained regions indicated phase separation at 75% replacement. Similar CLSM diagrams of phase-separated fat-replaced spreads showing continuous stained and unstained regions were observed for spreads fat-replaced with aqueous dispersions of hydrocolloids (Clegg et al., 1996; Mounsey, Stathopoulos, Chockchaisawasdee, O'kennedy, Gee and Doyle, 2008).

The confocal microscopy indicated that the microstructure of the prepared full fat spread was similar to that to the commercial full fat (refer to FIGS. 19b and c) and commercial low fat spreads (FIG. 19). The commercial low-fat spread structure (FIG. 19d) was uniform with fewer aqueous phase globules compared to the prepared low calorie spreads (FIGS. 18b, c, d, f, g, h). This difference probably arose from a difference in the preparation procedures and ingredients used for the commercial low fat spread compared to those used for the prepared low calorie spreads prepared in the present research. Commercial low fat spreads usually require more unique ingredients and preparation condition such as structuring agents and homogenization regimes compared to those applied for the prepared low calorie spreads in the present research. Chronakis (1997) showed that homogenization intensity has to be increased when fat replacement is done in order to improve the dispersion of the aqueous phase components. Therefore in the present study, the low calorie spreads with the aqueous dispersions of tef and maize starch nanomaterial probably need to be reformulated with additional ingredients that are required for low fat spreads in order to attain a structure similar to that of the commercial low fat spreads. FIG. 19 shows confocal laser scanning images of a prepared full fat spread (a), and reference commercial full fat bar spread (b), commercial full fat tub spread (c), and commercial low-fat tub spreads (d). Scale bars on the bottom right corners=50 μm. The red stained material is the fat phase while the dark unstained component is the aqueous phase. Bold white arrows indicate non-stained relatively regularly shaped regions.

In order to attain a structurally stable low-fat spread, two biopolymers with contrasting water holding capacities (one-low, and the other-high) may be used (Cain, Clark, Dunphy, Jones, Norton and Ross-Murphy, 1990; Chronakis and Kasapis, 1995a). In the present research, since the nanomaterials have limited water holding capacity as amylose-complexes are insoluble in water, another additional water holding polymer such as gelatin, carboxymethyl cellulose or xanthan gum may be required. Increasing the amount of added emulsifier is necessary for stabilization of reduced fat spreads due to the high amount of water included (Borwanker and Buliga, 1990). Since the level of emulsifier used in the present research was constant for all levels of fat replacement, reformulation with amounts of emulsifier proportional to the amount of water added may give more structurally stable low fat spreads.

In conclusion, the level of margarine fat replacement with added aqueous dispersions of tef and normal maize starch nanomaterial affects the textural, viscoelastic and microscopic structural properties of resultant low-calorie spreads. The spreads at 25% w/w fat replacement do not significantly deviate from the commercial samples in viscoelastic, textural and microscopic properties. Based on the fact that matching the texture of fat-replaced food products with that of commercial or standard full fat food products can facilitate replacement of fats in food products such as spreads (Jones, 1996; Radocaj, Dimic, Diosady and Vujasinovic, 2011); fat replacement at 25% w/w with the aqueous dispersions of the tef or maize nanomaterial was probably the optimum level in the present study. This study, therefore, demonstrates the potential of aqueous dispersions of tef and maize starch nanomaterial as fat replacers in margarine type spreads. However, in order to increase the level of fat replacement (to >25% w/w) without affecting the rheological and microscopic properties of the low-calorie spreads, further studies involving the homogenization regime and the other ingredients are required.

It shall be understood that the examples are provided for illustrating the invention further and to assist a person skilled in the art with understanding the invention and are not meant to be construed as unduly limiting the reasonable scope of the invention.

### REFERENCES

The references used for above section are presented below according to the Harvard reference format.

### 1. Method for Manufacturing Amylose Lipid Complexes:

Biais, B., Le Bail, P., Robert, P., Pontoire, B. & Buleon, A. 2006. Structural and Stoichiometric Studies of Complexes between Aroma Compounds and Amylose. Polymorphic Transitions and Quantification in Amorphous and Crystalline Areas. Carbohydrate Polymers, 66, 306-315.
Biliaderis, C. G. & Galloway, G. 1989. Crystallization Behaviour of Amylose-V Complexes: Structure-Property Relationships. Carbahydrate Research, 189, 31-48.
Biliaderis, C. G. & Seneviratne, H. D. 1990. On the Supermolecular Structure and Metastability of Glycerol Monostearate-Amylose Complex. Carbohydrate Polymers, 13, 185-206.
Cheetham, N. W. H. & Tao, L. 1998. Variation in Crystalline Type with Amylose Content in Maize Starch Granules: An X-Ray Powder Diffraction Study. Carbohydrate Polymers, 36, 277-284.
Chen, H., Weiss. J. & Shahidi, F. 2006. Nanotechnology in Nutraceuticals and Functional Foods. Journal of Food Technology, 60, 30-6.
Chrastil, J. 1987. Improved colorimetric determination of amylose in starches or flours. Carbohydrate research, 159, 154-158.
Chronakis, I. S. 1998. On the Molecular Characteristics, Compositional Properties, and Structural-Functional Mechanisms of Maltodextrins: A Review. Critical Reviews in Food Science and Nutrition, 38, 599-637
Copeland, L., Blazek, J., Salman, H. & Tang, M. C. 2009. Form and Functionality of Starch. Food Hydrocolloids, 23, 1527-1534.
D'silva, T. V., Taylor, J. R. N. & Emmambux, M. N. 2011. Enhancement of Pasting Properties of Teff and Maize Starches through Wet-Heat Processing with Added Stearic Acid. Journal of Cereal Science, 53. 192-197.
Eliasson, A. C., Finstad, H. & G. L. 1988. A Study of Starch-Lipid Interaction Form Some Native and Modified Maize Starches. Starch/Starke, 40, 95-100
Gelders, G. G., J.P., D., Goesaert, H. & Delcour, J. A. 2005. Enzyme and Acid Resistance of Amylose-Lipid Complexes Differing in Amylose Chain Length, Lipid and Complexation Temperature. Carbohydrate Polymers, 60, 379-389.
Gelders, G. G., Vanderstukken. T. C., Goesaert, H. & Delcour, J. A. 2004. Amylose-Lipid Complexation: A New Fractionation Method. Carbohydrate Polymers, 56 447-458
Godet, M. C., Bizot, H. & Buleon, A. 1995. Crystallization of Amylose-Fatty Acid Complexes Prepared with Different Amylose Chain Lengths. Carbohydrate Polymers, 21, 41-52.
Godet, M. C., Bouchet, B., Colonna, P., Gallant, D. J. & Buleon, A. 1996. Crystalline Amylose-Fatty Acid Complexes: Morphology and Crystal Thickness. Journal of Food Science, 61, 1196-1201.
Heinemann, C., Martina, Z., Renggli, A., Escher, F. & Conde-Petit, B. 2005. Influence of Amylose-Flavor Complexation on Build-up and Breakdown of Starch Structures in Aqueous Food Model Systems. LWT-Food Science and Technology, 38, 885-894.
Helbert W. & Chanzy, H. 1994. Single Crystals of V-Amylose Complexed with N-Butanol or N-Pentanol: Structural Features and Properties. International Journal of Biological Macromolecules, 16, 207-213.
Hinkle, M. E. & Zobel, H. F. 1968. X-Ray Diffraction of Oriented Amylose Fibers. Iii. The Structure of Amylose-N-Butanol Complexes. Biopolymers, 6, 1119-1128.
Holm, J., Bjorck, I., Ostrowska, S., Eliasson, A.-C., Asp, N.-G., Lundquist, I. & Larsson, K. 1983. Digestibility of Amylose-Lipid Complexes Invitro and In-Vivo. Starch/Staerke, 35, 294-297.
Wiper, R., Gesang, T., Possart. W., Hennemann, O. D. & Boseck, S. 1995. Imaging Elastic Sample Properties with an Atomic Force Microscope Operating in the Tapping Mode. Ultramicroscopy, 60, 17-24.
Imberty, A., Buleon, A., Tran, V. & Perez, S. 1991. Recent Advances in Knowledge of Starch Structure. Starch/Starke, 43, 375-384.
Jane, J. 1992. Preparation and Food Applications of Physically Modified Starches. Trends in Food Science & Technology, 3, 145-148.
Jane, J., Shen, L., Wang, L. & Maningat, C. 1992. Preparation and Properties of Small-Particle Corn Starch. Cereal Chemistry, 69, 280-283.
Jane, L. J. & Robyt, J. F. 1984. Structure Studies of Amylose V-Complexes and Retrograded Amylose by Action of Alpha-Amylases, and New Method for Preparing Amylodextrins. Carbahydrate Research, 132, 105-118.
Jouquand, C., Ducruet, V. & Le Bail, P. 2006. Formation of Amylose Complexes with C6-Aroma Compounds in Starch Dispersions and Its Impact on Retention. Food Chemistry, 96. 461-470.
Karkalas, J., Ma, S., Morrison, W. R. & Pethrick, R. A. 1995. Some Factors Determining the Thermal Properties of Amylose Inclusion Complexes with Fatty Acids. Carbohydrate Research, 268, 233-247.
Karkalas, J. & Raphaelides. S. 1986. Quantitative Aspects of Amylose-Lipid Interactions. Carbohydrate Research, 157, 215-234.
Kim. J. Y. & Lim, S. T. 2009. Preparation of Nano-Sized Starch Particles by Complex Formation with n-Butanol. Carbohydrate Polymers, 76, 110-116.
Kim. J. Y. & Lim, S. T. 2010. Complex Formation between Amylomaize Dextrin and n-Butanol by Phase Separation System. Carbohydrate polymers, 82, 264-269.
Kim. J. Y., Yoon, J. W. & Lim, S. T. 2009. Formation and Isolation of Nanocrystal Complexes between Dextrins and N-Butanol. Carbohydrate Polymers, 78, 626-632.
Lalush, I., Bar, H., Zakaria, I., Eichler, S. & Shimoni, E. 2005 Utilization of Amylose-Lipid Complexes as Molecular Nanocapsules for Conjugated Linoleic Acid. Biomacromolecules 6, 121-130.
Le Bail, P., Rondeau, C. & Buleon, A. 2005. Structural Investigation of Amylose Complexes with Small Ligands: Helical Conformation, Crystalline Structure and Thermostability. International Journal of Biological Macromolecules, 35 1-7.
Le Corre, D., Bras, J. & Dufresne, A. 2010. Starch Nanoparticles: A Review. Biomacromolecules, 11, 1139-1153.
Lesmes, U., Shahar, C. H., Yizhak, S. & Eyal, S. 2009. Effects of Long Chain Fatty Acid Unsaturation on the Structure and Controlled Release Properties of Amylose Complexes. Food Hydrocolloids, 23, 667-675.
Linko, P. & Linko, Y. 1983. Extrusion Cooking and Bioconversions. Journal of Food Engineering 2, 243-257.
Malinski, E., Daniel, J. R. Zhang, X. X. & Whistler, R. L. 2003. Isolation of Small Starch Granules and Determination of Their Fat Mimic Characteristics. Cereal Chemistry, 80, 1-4.
Nelles, E. M., Dewar, J., Bason, M. L. & Taylor, J. R. N. 2000. Maize Starch Biphasic Pasting Curves. Journal of Cereal Science, 31, 287-294.
Nelles, E. M., Dewar, J., Van Der Merwe, C. F. & Taylor, J. R. N. 2003. Granule Integrity and Starch Solubility During Slow, Extended Pasting of Maize Starch—the Second Viscosity Peak. Starch/Starke, 55, 72-79.
Oberdörster, G., Oberdorster, E. & Oberdorster, J. 2005. Nanotoxicology: An Emerging Discipline Evolving from Studies of Ultrafine Particles. Environmental Health Perspectives, 113, 823-839.
Putaux, J. L., Cardoso, M. B., Dupeyre, D., Morin, M., Nulac, A. & Hu, Y. 2008. Single Crystals of V-Amylose Inclusion Complexes. Macromolecular Symposia, 273, 1-8.
Rappenecker, G. & Zugenmaier, P. 1981. Detailed Refinement of the Crystal Structure of Vh-Amylose. Carbohydrate Research, 89, 11-19.
Seneviratne, H. D. & Biliaderis, C. G. 1991. Action of Alpha-Amylases on Amylose-Lipid Complex Superstructures. Journal of Cereal Science, 13, 129-143.
Solares, S. D. 2008. Characterization of Deep Nanoscale Surface Trenches with Afm Using Thin Carbon Nanotube Probes in Amplitude Modulation and Frequency-Forcemodulation Modes. Measurement Science and Technology, 19, 1-10.
Sozer, N. & Kokini, J. L. 2009. Nanotechnology and Its Applications in the Food Sector. Trends in biotechnology, 27, 82-89.
Tufvesson, F. & Eliasson, A.-C. 2000. Formation and Crystallization of Amylose-Monoglyceride Complex in a Starch Matrix. Carbohydrate Polymers, 43, 359-365.
Tufvesson, F., M., W. & Eliasson, A.-C. 2003. Formation of Amylose-Lipid Complexes and Effects of Temperature Treatment. Part 2. Fatty Acids. Starch/Starke 55, 138-149.
Wang, B., Li, D., Wang, L., Chiu, Y. L., Chen, X. D. & Mao, Z. 2008. Effect of High-Pressure Homogenization on the Structure and Thermal Properties of Maize Starch. Journal of Food Engineering, 87, 436-444.
Wokadala, O. C., Ray Sinha, S. & Emmambux, M. N. 2012a. Occurrence of Amylose-Lipid Complexes in Teff and Maize Starch Biphasic Pastes. Carbohydrate Polymers, 90, 616-622.
Wokadala, O. C., Ray Sinha, S. & Emmambux, M. N. 2012b. V-amylose Structural Characteristics, Methods of Preparation, Significance, and Potential Applications. Food Reviews International, 28, 412-438.
Zabar, S., Lesmes, U., Katz, I., Shimoni, E. & Bianco-Peled, H. 2009a. Structural Characterization of Amylose-Long Chain Fatty Acid Complexes Produced Via the Acidification Method. Food Hydrocolloids, 24, 347.
Zabar, S., Lesmes, U., Katz, I., Shimoni, E. & Bianco-Peled, H. 2009b. Studying Different Dimensions of Amylose-Long Chain Fatty Acid Complexes: Molecular, Nano and Micro Level Characteristics. Food Hydrocolloids, 23, 1918-1925.
Zobel, H. F., French, A. D. & Hinkle, M. E. 1967. X-Ray Diffraction of Oriented Amylose Fibers. II. Structure of V-Amyloses. Biopolymers, 5, 837-845.

### 2. Use of Amylose Lipid Complexes as Fat Replacers for Foodstuffs:

Borwankar, R., Frye, L., Blaurock, A. & Sasevich, F. 1992. Rheological Characterization of Melting of Margarines and Tablespreads. Journal of Food Engineering, 16, 55-74.
Borwanker, R. P. & Buliga, G. S. 1990. Emulsion Properties of Margarines and Low-Fat Spreads. In: Wan, P. J. (ed.), Food Emulsions and Foams: Theory and Practice. American Institute of Chemical Engineers. 110 pages.
Byars, J. 2002. Effect of a Starch-Lipid Fat Replacer on the Rheology of Soft-Serve Ice Cream. Journal of Food Science, 67, 2177-2182
Byars, J. A., Fanta, G. F. & Felker, F. C. 2009. Rheological Properties of Dispersions of Spherulites from Jet-Cooked High-Amylose. Cereal Chemistry, 86, 76-81.
Cain, F. W., Clark, A. H., Dunphy, P. J., Jones, M. G., Norton, I. T. & Ross-Murphy, S. B. 1990. Edible Plastic Dispersion. United-States-Trademarks-and-Patents-Office.
Cheng, L., Lim, B., Chow. K., Chong, S. & Chang. Y. 2008. Using Fish Gelatin and Pectin to Make a Low-Fat Spread. Food Hydrocolloids, 22, 1637-1640.
Chronakis, I. S. 1997. Structural-Functional and Water-Holding Studies of Biopolymers in Low Fat Content Spreads. LWT-Food Science and Technology, 30, 36-44.
Chronakis, I. S 1998. On the Molecular Characteristics, Compositional Properties, and Structural-Functional Mechanisms of Maltodextrins: A Review. Critical Reviews in Food Science and Nutrition, 38, 599-637.
Chronakis, I. S. & Kasapis, S. 1995a. Preparation and Analysis of Water Continuous Very Low Fat Spreads. LWT-Food Science and Technology, 28, 488-494.
Chronakis, I. S. & Kasapis, S. 1995b. A Rheological Study on the Application of Carbohydrate-Protein Incompatibility to the Development of Low Fat Commercial Spreads. Carbohydrate Polymers, 28, 367-373.
Chrysan, M. M. 2005. Margarines and Spreads. In: Shahidi, F. (ed.), Bailey's Industrial Oil and Fat Products. John Wiley & Sons, Inc. 3616 pages.
Clegg, S. M., Moore, A. K. & Jones. S. A. 1996. Low-fat Margarine Spreads as Affected by Aqueous Phase Hydrocolloids. Journal of Food Science, 61, 1073-1079.
D'silva, T. V., Taylor, J. R. N. & Emmambux, M. N. 2011. Enhancement of Pasting Properties of Teff and Maize Starches through Wet-Heat Processing with Added Stearic Acid. Journal of Cereal Science, 53. 192-197.
De Man, L., Postmus, E., De Man, J. M. 1990. Textural and Physical Properties of North American Stick Margarines. Journal of American Oil Chemists' Society 67, 323-328.
Funami, T., Yada, H. & Nakao, Y. 1998. Curdlan Properties for Application in Fat Mimetics for Meat Products. Journal of Food Science, 63, 283-287.
Garzoan, G., Mckeith, F., Gooding, J., Felker, F., Palmquist, D. & Brewer, M. 2003. Characteristics of Low-Fat Beef Patties Formulated with Carbohydrate-Lipid Composites. Journal of Food Science, 68, 2050-2056.
Glibowski, P., Zarzycki, P. & Krzepkowska, M. 2008. The Rheological and Instrumental Textural Properties of Selected Table Fats. International Journal of Food Properties, 11, 678-686.
Goli, S. a. H., Sahri, M. M., Kadivar, M. & Keramat, J. 2009. The Production of an Experimental Table Margarine Enriched with Conjugated Linoleic Acid (CLA): Physical Properties. Journal of the American Oil Chemists' Society, 86, 453-458.
Harris, D. W. & Day, G. A. 1993. Structure Versus Functional Relationships of a New Starch Based Fat Replacer. Starch/Starke, 45, 221-226.
Jane, J. 1992. Preparation and Food Applications of Physically Modified Starches. Trends in Food Science & Technology, 3, 145-148.
Jones, S. A. 1996. Physica, Chemical, and Sensory Aspects of Fat Replacement. In: Roller, S. & Jones, S. A. (eds.), Handbook of Fat Replacers. New York, USA.: CRC Press. 336 pages.
Jonnalagadda, S. S. & Jones, J. M. 2005. Position of the American Dietetic Association: fat replacers. Journal of the American Dietetic Association, 105, 266-275.
Lai, O., Ghazali, H., Cho, F. & Chong, C. 1999. Flow Properties of Table Margarine Prepared from Lipase-Catalysed Transesterified Palm Stearin: Palm Kernel Olein Feedstock. Food Chemistry, 64, 221-226.
Laia, O., Ghazalia, H., Cho, F. & Chong, C. 2000. Physical and Textural Properties of an Experimental Table Margarine Prepared from Lipase-Catalysed Transesterified Palm Stearin: Palm Kernel Olein Mixture During Storage. Food Chemistry, 71, 173-179.
Lim, J Inglett G. E. & Lee, S. 2010. Response to Consumer Demand for Reduced-Fat Foods; Multi-Functional Fat Replacers. Japan Journal of Food Engineering, 11, 163-168.
Liu, H., Xua. X. M. & Guo, S. D. 2007. Rheological, Texture and Sensory Properties of Low-Fat Mayonnaise with Different Fat Mimetics. LWT-Food Science and Technology, 40, 946-954.
Lucca, P. A. & Tepper, B. J. 1994. Fat Replacers and the Functionality of Fat in Foods. Trends in Food Science & Technology, 5, 12-19.
Ma, Y., Cai, C., Wang, J. & Sun, D. W. 2006. Enzymatic Hydrolysis of Corn Starch for Producing Fat Mimetics. Journal of Food Engineering, 73, 297-303.
Malinski, E., Daniel, J. R., Zhang, X. X. & Whistler, R. L. 2003. Isolation of Small Starch Granules and Determination of Their Fat Mimic Characteristics. Cereal Chemistry, 80, 1-4.
Mcclements, D. J. 1998. Analysis of Food Emulsions. In: Nielsen, S. S. (ed.), Introduction to Food Analysis. New York: Chapman and Hall. 630 pages.
Mcclements, D. J. & Demetriades, K. 1998. An Integrated Approach to the Development of Reduced-Fat Food Emulsions. Critical Reviews in Food Science and Nutrition, 38, 511-536.
Mezger, T. 2006. Oscillatory tests. The Rheology Handbook. Hannover: Vincentz Network GmbH & Co.KG. 252 pages.
Mounsey, J. S., Stathopoulos, C. E., Chockchaisawasdee, S., O'kennedy, B. T., Gee, V. L. & Doyle, J. 2008. Effect of Zinc Fortifications on Rheological Properties and Micro-Structure of Water-in-Oil Spreads Containing K-Carrageenan. European Food Research and Technology, 227, 675-681.
Norizzah, A., Chong, C., Cheow, C. & Zaliha, O. 2004 Effects of Chemical Interesterification on Physicochemical Properties of Palm Stearin and Palm Kernel Olein Blends. Food Chemistry, 86, 229-235.
Pompei, C., Lucisano, M., Zanoni, B. & Casiraghi, E. 1988. Evaluation of Spreadability of Food Products by Penetration Tests and Panel Scores. Journal of Food Science, 53, 592-596.
Radocaj, O., Dimic, E., Diosady, L. L. & Vujasinovic, V. 2011. Optimizing the Texture Attributes of a Fat-Based Spread Using Instrumental Measurements. Journal of Texture Studies, 42, 394-403.
Rønn, B. B., Hyldig. G., Wienberg. L., Qvist, K. B. & Laustsen, A. M. 1998. Predicting Sensory Properties from Rheological Measurements of Low-Fat Spreads. Food quality and preference, 9, 187-196.
Rousseau, D., Hill, A. R. & Marangoni, A. G. 1996. Restructuring Butterfat through Blending and Chemical Interesterification. Journal of the American Oil Chemists' Society, 73, 983-989.
Saadi, S., Ariffin, A. A., Ghazali, H. M., Abdulkarim, M. S., Boo, H. C. & Miskandar, M. S. 2012. Crystallisation Regime of W/O Emulsion [e.g. Multipurpose Margarine] Models During Storage. Food Chemistry, 133, 1485-1493.
Sandrou, D. K. & Arvanitoyannis, I. S. 2000. Low-Fat/Calorie Foods: Current State and Perspectives. Critical Reviews in Food Science and Nutrition, 40, 427-447
Shukla, A. & Rizvi, S. 2006. Viscoelastic Properties of Butter. Journal of Food Science, 60, 902-905.
Singh, M. & Byars, J. A. 2009. Starch-Lipid Composites in Plain Set Yogurt. International Journal of Food Science & Technology, 44. 106-110.
Singh, M. & Byars, J. A. 2011 Jet Cooked High Amylose Corn Starch and Shortening Composites for Use in Cake Icings. Journal of Food Science, 76, 530-535.
Tabilo-Munizaga, G. & Barbosa-Cánovas, G. V. 2005. Rheology for the Food Industry. Journal of Food Engineering, 67, 147-156.
Van Dalen, G. 2002 Determination of the Water Droplet Size Distribution of Fat Spreads Using Confocal Scanning Laser Microscopy. Journal of Microscopy, 208, 116-133.
Vithanage, C. R., Grimson, M. J. & Smith, B. G. 2009. The Effect of Temperature on the Rheology of Butter, a Spreadable Blend and Spreads. Journal of Texture Studies, 40, 346-369.
Warshaw, H., Franz, M., Powers, M. A. & Wheeler, M. 1996. Fat Replacers: Their Use in Foods and Role in Diabetes Medical Nutrition Therapy. Diabetes Care, 19, 1294.
Wokadala, O. C., Ray Sinha, S. & Emmambux, M. N. 2012. Occurrence of Amylose-Lipid Complexes in Teff and Maize Starch Biphasic Pastes. Carbohydrate Polymers, 90, 616-622.
Yackel, W. C. & Cox, C. 1992. Application of Starch-Based Fat Replacers. Journal of Food Technology, 46, 146-148.
Zhang, H., Jacobsen, C., Pedersen, L. S., Christensen, M. W. & Adler-Nissen. J. 2006. Storage Stability of Margarines Produced from Enzymatically Interesterified Fats Compared to Those Prepared by Conventional Methods—Chemical Properties. European Journal of Lipid Science and Technology, 108, 227-238.

1. A method for the manufacture of amylose-lipid complexes, which method comprises the steps of:
pasting a mixture of starch and a fatty acid until after the second biphasic peak viscosity is reached;
hydrolysing the starch with a hydrolysing enzyme; and
dispersing the hydrolysed starch and working up of the residue.

2. A method as claimed in claim 1, wherein the starch is selected from maize, tef, wheat, millet, sorghum, and the like.

3. A method as claimed in claim 1, wherein the fatty acid is selected from saturated fatty acids.

4. A method as claimed in claim 3, wherein the fatty acid is selected from stearic acid (octadecanoic acid) and palmitic acid (hexadecanoic acid).

5. A method as claimed in claim 1, wherein the pasting step also known as wet heat processing is executed in a Rapid Viscosity Analyser (RVA) or starch pasting rheometer may last for 130 minutes or more.

6. A method as claimed in claim 1, wherein the hydrolysing step is selected from thermo-stable alpha-amylase hydrolysis.

7. A method as claimed in claim 1, wherein the hydrolysing step is followed by an acetate buffer treatment.

8. A method as claimed in claim 7, wherein the buffer has a concentration of 0.05 M with a pH of 3.5 and the treatment at 95° C. for 20 min.

9. Use of amylose-lipid complexes manufactured according to a method as claimed in claim 1 in food stuffs as a fat replacer.

10. Use of amylose-lipid complexes as claimed in claim 9, wherein between 25% and 50% w/w of a low calorie spread is replaced with amylose-lipid complexes.

11. A low calorie spread which includes a spread mixed with between 25% and 50% w/w amylose-lipid complexes.

12. A low calorie spread as claimed in claim 11, wherein the spread is selected from margarine.

13. (canceled)

14. (canceled)

15. (canceled)
